(19) United States
(12) Patent Application Publication
(10) Pub. No.: US 2026/0120266 A1
(43) Pub. Date: Apr. 30, 2026

(54) IMAGE PROCESSING DEVICE, OPTICAL APPARATUS, IMAGE PROCESSING METHOD, AND METHOD OF USING OPTICAL APPARATUS

(71) Applicant: Lasertec Corporation, Yokohama (JP)

(72) Inventors: Toru ADACHI, Yokohama-shi (JP); Hiroki MIYAI, Yokohama-shi (JP)

(21) Appl. No.: 18/968,393

(22) Filed: Dec. 4, 2024

(30) Foreign Application Priority Data
Dec. 5, 2023 (JP) 2023-205023
Nov. 22, 2024 (JP) 2024-203938

(51) Int. Cl. G06T 7/00

(52) U.S. Cl. CPC G06T 7/0008; G06T 7/0006; G06T 7/001; G06T 2207/30148

(57) ABSTRACT

An image processing device according to the present embodiment includes: a setting unit configured to set a first parameter for a first pattern extending in a first direction on a reference image plane, based on a first sample image area that is an area including the first pattern, and set a second parameter for a second pattern extending in a second direction orthogonal to the first direction, based on a second sample image area that is an area including the second pattern; an obtaining unit configured to obtain a specimen image that is a captured image taken through a predetermined image capturing optical system by capturing an image of a specimen that has a third pattern extending in the first direction and a fourth pattern extending in the second direction; and a processing unit configured to perform predetermined information processing for the specimen image.

### INCORPORATION BY REFERENCE

This application is based upon and claims the benefit of priority from Japanese patent application No. 2023-205023, filed on Dec. 5, 2023, and Japanese patent application No. 2024-203938, filed on Nov. 22, 2024, the disclosure of which is incorporated herein in its entirety by reference.

### BACKGROUND

The present disclosure relates to an image processing device, an optical apparatus, an image processing method, and a method of using the optical apparatus.

Patent Literature 1 describes a technique of performing a photomask defect inspection by illuminating a photomask with EUV (Extreme Ultra Violet) light.
[Patent Literature 1] Japanese Patent No. 6249513

### Non Patent Literature

[Non Patent Literature 1] Masaki Hayashi, “CVML Expert Guide”, [online], [retrieved Nov. 6, 2024], Internet <URL: https://cvml-expertguide.net/2021/07/12/spatial-filtering/>

### SUMMARY

The design or setting difference of an optical apparatus may lead to a varying appearance of a pattern or a varying appearance of a defect in an inspection image due to a difference in angle between a direction in which the pattern of a photomask extends and an incident direction of illumination light, or a difference in NA or magnification. For example, even with a pattern plane with the same design, due to whether the incidence occurs in the pattern extending direction or the direction orthogonal the pattern extending direction relative to the pattern plane, or due to the difference in NA or magnification, a varying appearance of the pattern or a varying appearance of a defect in the inspection image may result. According to the difference in NA or the difference in magnification in a direction corresponding to each direction on the captured image, even with pattern planes of the same design or the same defect, a varying appearance of a pattern or a varying appearance of a defect depending on the capturing direction may result. Consequently, an inspection in consideration of the difference in sensitivity and appearance due to the pattern image capturing direction or the specimen capturing direction may be required.

The present disclosure has been made in view of such a problem, and provides an image processing device, an optical apparatus, an image processing method, and a method of using the optical apparatus that are capable of appropriately addressing a difference in sensitivity and appearance due to the pattern image capturing direction or the specimen capturing direction.

An image processing device according to an aspect of the present embodiment includes: a setting unit configured to set a first parameter for a first pattern extending in a first direction on a reference image plane, based on a first sample image area that is an area including the first pattern, and set a second parameter for a second pattern extending in a second direction orthogonal to the first direction on the reference image plane, based on a second sample image area that is an area including the second pattern; an obtaining unit configured to obtain a specimen image that is a captured image taken through a predetermined image capturing optical system by capturing an image of a specimen that has a third pattern extending in the first direction in the captured image and a fourth pattern extending in the second direction, with a plane of the captured image being adopted as the reference image plane; and a processing unit configured to perform predetermined information processing based on the first parameter and the second parameter, for the specimen image.

In the image processing device described above, the setting unit may set the first parameter so as to include a threshold used for determination of presence or absence of a defect in the third pattern included in the specimen image, and set the second parameter so as to include a threshold used for determination of presence or absence of a defect in the fourth pattern included in the specimen image, and the processing unit may perform the predetermined information processing that includes the determination of presence or absence of a defect in the third pattern and the fourth pattern that are included in the specimen image.

In the image processing device described above, the specimen image may include both the third pattern and the fourth pattern, and the processing unit may perform the predetermined information processing that includes the determination of presence or absence of a defect in the third pattern and the fourth pattern that are included in the specimen image.

In the image processing device described above, the setting unit may set the threshold for a plurality of types of physical quantities for information about the specimen image.

In the image processing device described above, the setting unit may perform setting such that at least an item between the types and number of physical quantities about which the threshold is defined as the first parameter is different from the item of the physical quantities about which the threshold is defined as the second parameter.

In the image processing device described above, at least any of the first sample image area and the second sample image area may be an area included in an image generated based on design data for the specimen or design data for a pattern formed on the specimen.

In the image processing device described above, the first sample image area may be an area included in the captured image of a target object having the first pattern, the captured image having been taken through the predetermined image capturing optical system.

In the image processing device described above, the first sample image area and the second sample image area may be areas included in the captured image of a target object having the first pattern and the second pattern, the captured image having been taken through the predetermined image capturing optical system.

In the image processing device described above, the first sample image area and the second sample image area may be areas included in the captured image of the target object having the first pattern, the captured image having been taken through the predetermined image capturing optical system, and
an orientation of the target object with respect to the predetermined image capturing optical system during capture of the captured image including the first sample image area, and an orientation of the target object with respect to the predetermined image capturing optical system during capture of the captured image including the second sample image area may differ by 90° on a principal plane of the target object.

In the image processing device described above, the predetermined image capturing optical system may capture an image with oblique incidence illumination on the target object, and the first sample image area may be included in the captured image when an angle between a direction in which a principal axis of the oblique incidence illumination is projected on an upper surface of the target object, and the first direction is a predetermined angle.

In the image processing device described above, the predetermined image capturing optical system may capture an image with oblique incidence illumination on the target object, and the first sample image area and the second sample image area may be included in the captured image when an angle between a direction in which a principal axis of the oblique incidence illumination is projected on an upper surface of the target object, and the first direction is a predetermined angle.

In the image processing device described above, the predetermined image capturing optical system may capture an image with oblique incidence illumination on the specimen, and the specimen image may be a captured image through the predetermined image capturing optical system when an angle between a direction in which a principal axis of the oblique incidence illumination is projected on an upper surface of the specimen, and the first direction is a predetermined angle.

In the image processing device described above, the specimen may include an anamorphic mask.

In the image processing device described above, the obtaining unit may obtain the specimen image where the number of pixels for binning differs between the first direction and the second direction.

In the image processing device described above, the predetermined image capturing optical system may have an NA that differs between the first direction and the second direction.

In the image processing device described above, the setting unit may set the first parameter so as to include a correction value for luminances of pixels belonging to the third pattern included in the specimen image, and set the second parameter so as to include a correction value for luminances of pixels belonging to the fourth pattern included in the specimen image, and the processing unit may perform the predetermined information processing that includes image correction for the specimen image.

An optical apparatus according to an aspect of the present embodiment includes: an illumination optical system configured to illuminate the specimen; the predetermined image capturing optical system configured to capture an image of the illuminated specimen; and the image processing device described above.

An image processing method according to an aspect of the present embodiment includes: a step of setting a first parameter for a first pattern extending in a first direction on a reference image plane, based on a first sample image area that is an area including the first pattern; a step of setting a second parameter for a second pattern extending in a second direction orthogonal to the first direction on the reference image plane, based on a second sample image area that is an area including the second pattern; a step of obtaining a specimen image that is a captured image taken through a predetermined image capturing optical system by capturing an image of a specimen that has a third pattern extending in the first direction in the captured image and a fourth pattern extending in the second direction, with a plane of the captured image being adopted as the reference image plane; and a step of performing predetermined information processing based on the first parameter and the second parameter, for the specimen image.

A method of using an optical apparatus according to an aspect of the present embodiment includes: a step of illuminating the specimen; a step of capturing an image of the illuminated specimen; and the image processing method described above.

The present disclosure can provide an image processing device, an optical apparatus, an image processing method, and a method of using the optical apparatus that are capable of appropriately addressing a difference in sensitivity due to the pattern image capturing direction.

The above and other objects, features and advantages of the present disclosure will become more fully understood from the detailed description given hereinbelow and the accompanying drawings.

### BRIEF DESCRIPTION OF DRAWINGS

FIG. 1 is a configuration diagram showing an example inspection apparatus according to a first embodiment;

FIG. 2 shows an example mask pattern of a specimen according to the first embodiment;

FIG. 3 shows an example image of the specimen according to the first embodiment captured such that the mask pattern extends in a first direction;

FIG. 4 shows an example image of the specimen according to the first embodiment captured such that the mask pattern extends in a second direction;

FIG. 5 is a block diagram showing an example image processing device according to the first embodiment;

FIG. 6 shows an example mask pattern of a specimen for a sample image according to the first embodiment;

FIG. 7 shows an example mask pattern of a specimen for a sample image according to the first embodiment;

FIG. 8 shows an example mask pattern of a specimen for a sample image according to the first embodiment;

FIG. 9 shows an example first sample image obtained by an obtaining unit in the image processing device according to the first embodiment;

FIG. 10 shows an example second sample image obtained by the obtaining unit in the image processing device according to the first embodiment;

FIG. 11 shows a captured image obtained by the obtaining unit in the image processing device according to the first embodiment;

FIG. 12 is a graph showing an example of the relationship between the difference signal between predetermined pixels and the occurrence probability in the captured image obtained by the obtaining unit in the image processing device according to the first embodiment, the abscissa axis indicates the difference signal, and the ordinate axis indicates the occurrence probability;

FIG. 13 is a graph showing an example of the relationship between the difference signal between predetermined pixels and the occurrence probability in the captured image obtained by the obtaining unit in the image processing device according to the first embodiment, the abscissa axis indicates the difference signal, and the ordinate axis indicates the occurrence probability;

FIG. 14 is a flowchart showing an example image processing method using the image processing device according to the first embodiment;

FIG. 15 is a flowchart showing an example inspection method using the inspection apparatus according to the first embodiment;

FIG. 16 shows an example first pattern extending in a first direction, an example luminance distribution along a second direction in a first pattern, and an example one-dimensional kernel applied to the luminance distribution in an image processing device according to a second embodiment;

FIG. 17 shows an example second pattern extending in the second direction, an example luminance distribution along the first direction in a second pattern, and an example one-dimensional kernel applied to the luminance distribution in the image processing device according to the second embodiment;

FIG. 18 shows an example luminance distribution in a reference shape along a direction orthogonal to the pattern extending direction in the image processing device according to the second embodiment;

FIG. 19 is a schematic diagram showing example information processing performed for a specimen image or an image based on the specimen image by a processing unit in the image processing device according to the second embodiment;

FIG. 20 shows example difference images in the image processing device according to a modification example 1 of the second embodiment; and

FIG. 21 is a flowchart showing an example image processing method using the image processing device according to the second embodiment.

### DESCRIPTION OF EMBODIMENTS

Hereinafter, embodiments of the present disclosure are described with reference to the drawings. The following description indicates preferred embodiments in the present disclosure, and the scope of the present disclosure is not limited to the following embodiments. In the following description, components assigned the same symbols indicate substantially similar contents.

### First Embodiment

An image processing device, an optical apparatus, an image processing method, and a method of using the optical apparatus according to a first embodiment are described. First, <Inspection Apparatus> describes an inspection apparatus as an example of the optical apparatus. Next, <Pattern> describes pattern of specimens that can serve as inspection targets or the like. Next, <Image Processing Device> describes an image processing device included in the optical apparatus. Next, <Image Processing Method> and <Inspection Method> describe an image processing method using the image processing device, and an inspection method as an example of a method of using the optical apparatus.

Note that the image processing device and the image processing method as examples of the present disclosure may be used for the inspection apparatus as described with the following embodiment, but are not limited to them. For example, the image processing device and the image processing method as the examples of the present disclosure may be used as an apparatus (review apparatus) that displays, on a display or the like, an image (captured image) acquired as a result of illuminating a specimen.

### <Inspection Apparatus>

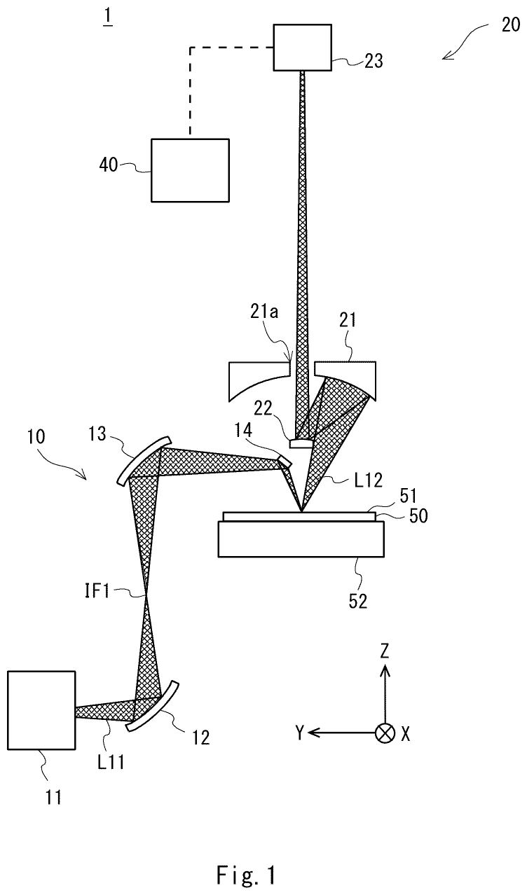

FIG. 1 is a configuration diagram showing an example inspection apparatus 1 according to the first embodiment. The inspection apparatus 1 includes an illumination optical system 10, an image capturing optical system 20, and an image processing device 40. The illumination optical system 10 illuminates a specimen 50 with illumination light L11. Similar to the case of the specimen 50, the illumination optical system 10 may illuminate, with the illumination light L11, a target object used to obtain a first sample image area and a second sample image area, which are described later. The illumination optical system 10 includes, for example, a light source 11, an ellipsoidal mirror 12, an ellipsoidal mirror 13, and a drop mirror 14. The image capturing optical system 20 captures a captured image of the specimen 50 illuminated with the illumination light L11. Note that the captured image of the specimen 50 may be referred to as a specimen image. The image capturing optical system 20 includes, for example, an aperture concave mirror 21, a convex mirror 22, and a detector 23. The aperture concave mirror 21 and the convex mirror 22 constitute a Schwarzschild magnification optical system. Note that the illumination optical system 10 and the image capturing optical system 20 may further include an optical member other than the members described above, and any of the optical members described above may be omitted.

Here, for the sake of convenience of describing the inspection apparatus 1, an XYZ orthogonal coordinate system is introduced. For example, a plane in parallel with a stage surface of a stage 52 on which the specimen 50 is disposed is called an XY plane, and a direction orthogonal to the stage surface is called a Z-axis direction. For the sake of convenience, +Z-axis direction is called an upward sense, and −Z-axis direction is called a downward sense. Note that the upward and downward senses are for convenience of describing the inspection apparatus 1, and is not for indicating a direction in which an actual inspection apparatus 1 is disposed.

The light source 11 generates the illumination light L11. The illumination light L11 contains, for example, EUV light at 13.5 nm, which is identical to the exposure wavelength of an EUV mask as the specimen 50. The illumination light L11 generated by the light source 11 is reflected by the ellipsoidal mirror 12. The illumination light L11 reflected by the ellipsoidal mirror 12 travels while being focused, and is concentrated on a focusing point IF1. The focusing point IF1 is disposed at a position conjugate to an upper surface 51 of the specimen 50.

After passing through the focusing point IF1, the illumination light L11 travels as it expands, and is incident on a reflecting mirror, such as the ellipsoidal mirror 13. The illumination light L11 incident on the ellipsoidal mirror 13 is reflected by the ellipsoidal mirror 13, travels as it is narrowed, and is incident on the drop mirror 14. That is, the ellipsoidal mirror 13 causes the illumination light L11 to be convergent light and incident on the drop mirror 14. The drop mirror 14 is disposed above the specimen 50. The illumination light L11 having been incident on and reflected by the drop mirror 14 is incident on the specimen 50. That is, the drop mirror 14 causes the illumination light L11 to be incident on the specimen 50.

The ellipsoidal mirror 13 collects the illumination light L11 on the specimen 50. The illumination optical system 10 is installed so as to form an image of the light source 11 on the upper surface 51 of the specimen 50 when the specimen 50 is illuminated with the illumination light L11. Accordingly, the illumination optical system 10 is of critical illumination. Thus, the illumination optical system 10 illuminates the specimen 50 using the critical illumination due to the illumination light L11 generated by the light source 11.

The specimen 50 is disposed on the stage 52. The illumination light L11 is incident on the specimen 50 in a direction inclined from the Z-axis direction. That is, the illumination light L11 is obliquely incident on the specimen 50 as oblique incidence illumination. The specimen 50 may be illuminated with the illumination light L11 as such oblique incidence illumination.

The stage 52 is an XYZ drive stage. By moving the stage 52 in the X-axis direction and the Y-axis direction, a desired area on the specimen 50 can be illuminated. Furthermore, by moving the stage 52 in the Z-axis direction, focus adjustment can be achieved. The stage 52 may be rotated about X-, Y-, and Z-axes directions as rotation axes. Note that instead of moving and rotating the stage 52 along and about the X-axis direction, the Y-axis direction, and the Z-axis direction, the illumination optical system 10 and the image capturing optical system 20 may be moved and rotated.

An inspection area on the specimen 50 is illuminated with the illumination light L11 from the light source 11. The reflected light L12 having been incident in a direction inclined from the Z-axis direction and reflected by the specimen 50 is incident on the aperture concave mirror 21. At the center of the aperture concave mirror 21, an aperture 21a is provided.

The reflected light L12 reflected by the aperture concave mirror 21 is incident on the convex mirror 22. The convex mirror 22 reflects the reflected light L12 having been incident through the aperture concave mirror 21, toward the aperture 21a of the aperture concave mirror 21. The reflected light L12 having passed through the aperture 21a is detected by the detector 23. The detector 23 may be a detector 23 that includes a TDI (Time Delay Integration) sensor. The detector 23 obtains image data of the specimen 50. The detector 23 includes a plurality of image capturing elements linearly arranged in one direction. Linear image data captured by the linearly arranged image capturing elements is called one-directional image data or one frame. The detector 23 obtains a plurality of one-directional image data items by scanning in a direction orthogonal to the one direction. The image capturing element is, for example, a CCD (Charge Coupled Device). Note that the image capturing element is not limited to the CCD.

As described above, the image capturing optical system 20 collects the reflected light L12 from the specimen 50 illuminated with the illumination light L11, detects the collected reflected light L12 through the detector 23, and obtains image data of the specimen 50. The image data is, for example, one-directional image data. Note that the image capturing optical system 20 collects the reflected light L12 from a target object illuminated with the illumination light L11, detects the collected reflected light L12 through the detector 23, and obtains image data of the target object.

The reflected light L12 includes information, such as about a defect of the specimen 50. Specular reflected light of the illumination light L11 having been incident on the specimen 50 in the direction inclined from the Z-axis direction is detected by the image capturing optical system 20. In case there is a defect in the specimen 50, the defect is observed as a dark image. Such an observation method is called bright-field observation. A plurality of one-directional image data items of the specimen 50 obtained by the detector 23 are output to the image processing device 40, and are processed as two-dimensional image data.

The image processing device 40 is connected to the image capturing optical system 20 by a signal line or wirelessly. The image processing device 40 receives the image data of the specimen 50 from the detector 23 in the image capturing optical system 20. The image processing device 40 processes the image data of the specimen 50 received from the detector 23, as two-dimensional captured image. The image processing device 40 inspects the specimen 50 using the image-processed captured image.

According to such a configuration, the inspection apparatus 1 inspects a defect, contamination and the like of the specimen 50. The specimen 50 is, for example, an EUV mask compatible with the EUV light. Note that the specimen 50 is not limited to the EUV mask. The specimen 50 may be a photomask compatible with illumination light L11 having a different wavelength, or a semiconductor substrate. The photomask has a pattern.

### <Pattern>

Next, a pattern formed on the specimen 50 is described. For example, a mask pattern of a photomask is described. Note that the pattern is not limited to the mask pattern, and may be a pattern or the like formed on a semiconductor substrate. Note that patterns of the specimen 50 that is a target of predetermined information processing, such as determination of presence or absence of a defect, is described here as an example. This description for patterns of the specimen 50 can be applied to patterns of a target object used to obtain a first sample image area and a second sample image area which is described later. Here, the target object used to obtain the first sample image area and the second sample image area may be an object identical to or different from the specimen 50 that is a target subjected to predetermined information processing, such as determination of presence or absence of a defect.

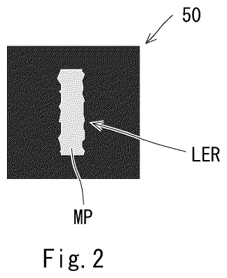

FIG. 2 shows an example mask pattern MP of the specimen 50 according to the first embodiment. As shown in FIG. 2, the specimen 50 includes the mask pattern MP. The mask pattern MP may include, on an edge portion, a fabrication error formed in production, which is called line edge roughness (hereinafter called LER).

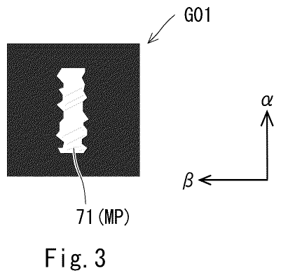

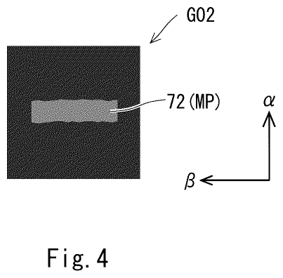

FIG. 3 shows an example image of the specimen 50 according to the first embodiment captured such that the mask pattern MP extends in a first direction. FIG. 4 shows an example image of the specimen 50 according to the first embodiment captured such that the mask pattern MP extends in a second direction. As shown in FIG. 3, in an image G01, the mask pattern MP extends in the first direction. As shown in FIG. 4, in an image G02, the mask pattern MP extends in the second direction orthogonal to the first direction.

Here, an αβ orthogonal coordinate axes system is introduced into the image plane. For example, the image plane may be referred to as a reference image plane. In the image plane, the longitudinal direction is called an α-axis direction, and the transverse direction is called a β-axis direction. The α-axis direction is called a first direction, and the β-axis direction is called a second direction. Accordingly, the mask pattern MP in the image G01 extends in the α-axis direction, and the mask pattern MP in the image G02 extends in the β-axis direction.

The α-axis direction and the β-axis direction may respectively correspond to the X-axis direction and the Y-axis direction on the stage 52, but are not necessarily correspond to the X-axis direction and the Y-axis direction on the stage 52. For example, the α-axis direction and the β-axis direction on the reference image plane are respectively configured to correspond to the X-axis direction and the Y-axis direction on the stage 52. Consequently, when the mask pattern MP shown in FIG. 2 is disposed along the X-axis direction on the stage 52, an image is captured so as to be along the α-axis direction as in the image G01 in FIG. 3. On the other hand, when the mask pattern MP shown in FIG. 2 is disposed along the Y-axis direction on the stage 52, an image is captured so as to be along the β-axis direction as in the image G02 in FIG. 4. By disposing the same mask pattern MP along the X-axis direction or the Y-axis direction on the stage 52 as described above, the image is captured so as to be along the α-axis direction or the β-axis direction.

Hereinafter, for the sake of convenience of description, it is assumed that when the mask pattern MP of the specimen 50 is disposed so as to extend in the X-axis direction on the stage 52, an image of the mask pattern MP is captured so as to extend in the α-axis direction. It is also assumed that when the mask pattern MP is disposed so as to extend in the Y-axis direction on the stage 52, an image of the mask pattern MP is captured so as to extend in the β-axis direction.

Note that depending on the number and types of optical members constituting the image capturing optical system 20, an image of the mask pattern MP may be captured so as to be along the β-axis direction when the mask pattern MP is disposed so as to extend in the X-axis direction on the stage 52, and an image of the mask pattern MP may be captured so as to extend in the α-axis direction when the mask pattern MP is disposed so as to extend in the Y-axis direction on the stage 52.

The image of the mask pattern MP captured so as to extend in the a-axis direction when the image of the specimen 50 is captured is called a first pattern 71 or a third pattern 73. For example, a mask pattern MP on the first sample image including a first sample image area described later among mask patterns MP extending in the α-axis direction adopted as the first direction on an image plane serving as a reference is the first pattern 71. For example, a mask pattern MP on a captured specimen image of a target subjected to predetermined information processing, such as determination of presence or absence of a defect, described later, among the mask patterns MP extending in the α-axis direction adopted as the first direction on the image plane serving as the reference is the third pattern 73.

The image of the mask pattern MP captured so as to extend in the β-axis direction when the image of the specimen 50 is captured is called a second pattern 72 or a fourth pattern. For example, a mask pattern MP on the second sample image including a second sample image area described later among mask patterns MP extending in the β-axis direction adopted as the second direction orthogonal to the first direction on the image plane serving as the reference is the second pattern 72. For example, a mask pattern MP on a captured specimen image of a target subjected to predetermined information processing, such as determination of presence or absence of a defect, described later, among the mask patterns MP extending in the β-axis direction adopted as the second direction orthogonal to the first direction on the image plane serving as the reference is the fourth pattern 74.

For example, the image G01 and the image G02 may be images of the specimen 50 captured through the image capturing optical system 20 having a numerical aperture (hereinafter called NA) different between the X-axis direction and the Y-axis direction. Specifically, the image G01 may be a captured image of the specimen 50 having the mask pattern MP when the mask pattern MP is disposed on the stage 52 so as to extend in the X-axis direction. That is, the image G01 may be a captured image of the specimen 50 having the mask pattern MP when this specimen is disposed on the stage 52 so as to have the first pattern 71. The image G02 may be a captured image of the specimen 50 having the mask pattern MP when the mask pattern MP is disposed on the stage 52 so as to extend in the Y-axis direction. That is, the image G02 may be a captured image of the specimen 50 having the mask pattern MP when this specimen is disposed on the stage 52 so as to have the second pattern 72. The image capturing optical system 20 may be an image capturing optical system having NA different between the first direction and the second direction orthogonal to the first direction, with the captured image being adopted as the reference image plane. The image capturing optical system may be an image capturing optical system having magnifications different between the first direction and the second direction orthogonal to the first direction, with the captured image being adopted as the reference image plane.

For example, the image G01 and the image G02 may be images captured with the angle between the principal axis of the oblique incidence illumination and the mask pattern MP extending direction being changed. For example, the image G01 may be an image captured such that the angle between the direction in which the principal axis of the oblique incidence illumination is projected on the upper surface of the specimen 50 and the X-axis direction in which the mask pattern MP extends is a predetermined angle. The image G02 may allow the principal axis of the oblique incidence illumination to have the same direction as the image G01. In this case, the image is captured such that the mask pattern MP extends in the Y-axis direction, and the angle between the direction in which the principal axis of the oblique incidence illumination is projected on the upper surface of the specimen 50 and the Y-axis direction in which the mask pattern MP extends is an angle different substantially by 90° from the predetermined angle. Here, substantial 0° and substantial 90° means not only strict 0° and strict 90° but also 0° and 90° in a range including errors in measurement and on the device. Note that angles, such as of 0° and 90°, described below may be used as meaning including representation of a substantial range even in a case without explicit representation of the substantial range.

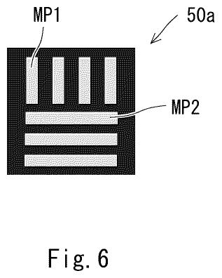

For example, the image G01 and the image G02 may be images taken by capturing the mask patterns MP of the specimen (for example, FIG. 6 described later) having both the mask pattern MP extending in the X-axis direction and the mask pattern MP extending in the Y-axis direction, with the oblique incidence illumination.

As shown in FIGS. 3 and 4, depending on the orientation of the mask pattern MP during capture, the magnitude of effect of LER on the image changes. For example, in some cases, since the NA of the image capturing optical system 20 used for the inspection apparatus for a photomask using EUV light differs between the X-axis direction and the Y-axis direction, the image G01 and the image G02 have different resolutions between the α-axis direction and the β-axis direction. For example, the appearance of the mask pattern MP differs between the resolution in view of the mask pattern MP laid along the α-axis direction (for example, assumed substantially as 0° direction) as in the first pattern 71 shown in FIG. 3, and the resolution in view of the mask pattern MP laid along the β-axis direction (for example, assumed as 90° direction) as in the second pattern 72 shown in FIG. 4. Thus, even with defects having the same shape, the detection sensitivity changes depending on whether the corresponding defect is on an edge of the pattern in the α-axis direction or on an edge of the pattern in the β-axis direction.

Accordingly, the image processing device 40 in the present embodiment can detect the mask patterns MP in the α-axis direction and the β-axis direction, and independently adjust the sensitivities in the respective directions. As described later specifically, a setting unit 42 of the image processing device 40 independently sets in each direction a parameter used for predetermined information processing that includes determination of presence or absence of a defect in each direction. Thus, algorithms different in the respective directions can be set, and the difference between sensitivities in the directions can be reduced.

### <Image Processing Device>

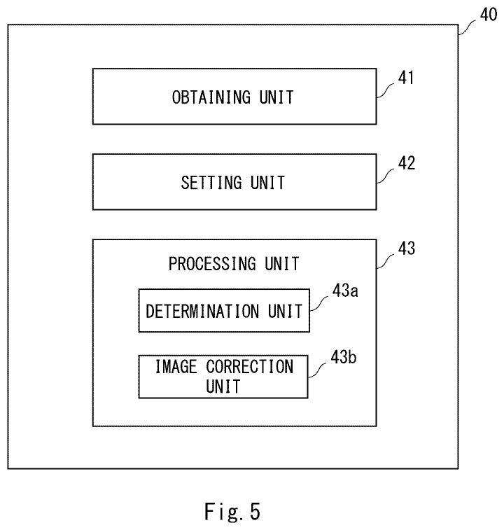

Next, the image processing device 40 is described. FIG. 5 is a block diagram showing an example image processing device 40 according to the first embodiment. As shown in FIG. 5, the image processing device 40 includes an obtaining unit 41, a setting unit 42, and a processing unit 43. The obtaining unit 41, the setting unit 42, and the processing unit 43 have functions as obtaining means, setting means, and processing means, respectively. Note that the image processing device 40 may further include a unit that has another function, such as a storage unit serving as storing means. The processing unit 43 may be at least any of a determination unit 43a and an image correction unit 43b, which are described later. The determination unit 43a and the image correction unit 43b have functions as determination means and image correction means, respectively.

The obtaining unit 41 obtains the first sample image area and the second sample image area. In actuality, the first sample image area and the second sample image area may be obtained from captured images of a target object prepared for obtaining the first sample image area and the second sample image area, or may be obtained from images formed from designed data. Images for obtaining the first sample image area and the second sample image area are called sample images. Consequently, the sample images may be images captured through the image capturing optical system 20, or images based on design data.

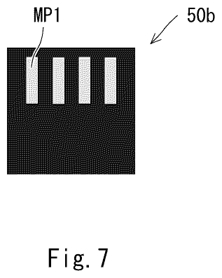

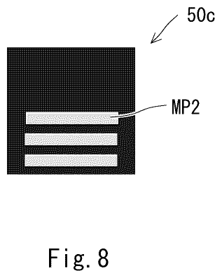

FIGS. 6 to 8 show example mask patterns of MP1 and MP2 of specimens 50a to 50c for sample images according to the first embodiment. As shown in FIGS. 6 to 8, the specimens 50a to 50c for sample images include at least any of the mask patterns MP1 and MP2. The specimens 50a to 50c may be referred to as target objects in order to distinguish them from the specimen 50 for the specimen image. As shown in FIG. 6, the specimen 50a for the sample image includes the mask patterns MP1 and MP2. As shown in FIG. 7, the specimen 50b for the sample image includes the mask pattern MP1. As shown in FIG. 8, the specimen 50c for the sample image includes the mask pattern MP2.

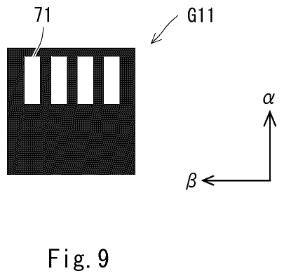

FIG. 9 shows an example first sample image G11 obtained by the obtaining unit 41 in the image processing device 40 according to the first embodiment. As shown in FIG. 9, the first sample image G11 includes the first pattern 71 extending in the α-axis direction in the image plane. An area that includes the first pattern 71 is called a first sample image area. Consequently, the first sample image G11 includes the first sample image area. The obtaining unit 41 may obtain the first sample image G11 and the first sample image area from a captured image of the specimen 50a for the sample image, or obtain the first sample image G11 and the first sample image area from a captured image of the specimen 50b for the sample image. That is, the first sample image area may be an area included in a captured image of a target object having the first pattern 71, the captured image having been taken through the predetermined image capturing optical system 20.

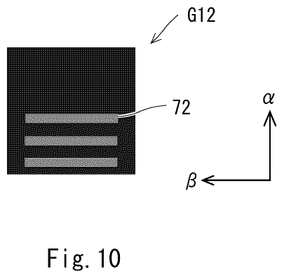

FIG. 10 shows an example second sample image G12 obtained by the obtaining unit 41 in the image processing device 40 according to the first embodiment. As shown in FIG. 10, the second sample image G12 includes the second pattern 72 extending in the β-axis direction in the image plane. An area that includes the second pattern 72 is called a second sample image area. Consequently, the second sample image G12 includes the second sample image area. The obtaining unit 41 may obtain the second sample image G12 and the second sample image area from a captured image of the specimen 50a for the sample image, or obtain the second sample image G12 and the second sample image area from a captured image of the specimen 50c for the sample image. That is, the second sample image area may be an area included in a captured image of a target object having the second pattern 72, the captured image having been taken through the predetermined image capturing optical system 20.

In the case of obtaining the first sample image G11 and the first sample image area with oblique incidence illumination onto the specimen 50a or the specimen 50b having the first pattern 71 on the stage 52, the obtaining unit 41 may obtain the first sample image G11 such that the angle between the direction in which the principal axis of the oblique incidence illumination is projected on the upper surface of the specimen 50a, and the X-axis direction in which the first pattern 71 extends (i.e., the first direction and the α-axis direction) is the predetermined angle. That is, the predetermined image capturing optical system 20 captures an image with oblique incidence illumination on the target object. The first sample image area is included in the captured image when the angle between the direction in which the principal axis of the oblique incidence illumination is projected on the upper surface of the target object, and the first direction is the predetermined angle.

In the case of obtaining the second sample image G12 and the second sample image area with oblique incidence illumination onto the specimen 50a or the specimen 50c having the second pattern 72, the obtaining unit 41 may obtain the second sample image G12 such that the angle between the direction in which the principal axis of the oblique incidence illumination is projected on the upper surface of the specimen 50a, and the Y-axis direction in which the second pattern 72 extends (i.e., the second direction and the β-axis direction) is an angle different by 90° from the predetermined angle. The predetermined image capturing optical system 20 captures an image with oblique incidence illumination on the target object. The first sample image area and the second sample image area may be included in the captured image when the angle between the direction in which the principal axis of the oblique incidence illumination is projected on the upper surface of the target object, and the first direction is the predetermined angle.

Furthermore, the obtaining unit 41 may obtain the second sample image G12 and the second sample image area from a captured image of the specimen 50b. That is, the specimen 50b is rotated by 90° about the Z-axis on the stage 52. Accordingly, the first pattern 71 can be captured as the second pattern. Likewise, the obtaining unit 41 may obtain the first sample image G11 and the first sample image area from a captured image of the specimen 50c. That is, the specimen 50c is rotated by 90° about the Z-axis on the stage 52. Accordingly, the second pattern 72 can be captured as the first pattern. As described above, the first sample image area and the second sample image area may be areas included in a captured image of a target object having the first pattern, the captured image having been taken through the predetermined image capturing optical system 20. In such cases, the orientation of the target object with respect to the predetermined image capturing optical system 20 during capture of the captured image including the first sample image area, and the orientation of the target object with respect to the predetermined image capturing optical system 20 during capture of the captured image including the second sample image area differ by 90° on the principal plane of the target object.

In the case of obtaining the first sample image G11, the first sample image area, the second sample image G12, and the second sample image area with oblique incidence illumination onto the specimen 50a having the first pattern 71 and the second pattern 72 on the stage 52, the obtaining unit 41 may obtain the first sample image G11, the first sample image area, the second sample image G12, and the second sample image area such that the angle between the direction in which the principal axis of the oblique incidence illumination is projected on the upper surface of the specimen 50a, and the X-axis direction (i.e., the first direction and the α-axis direction) is the predetermined angle. That is, the first sample image area and the second sample image area may be areas included in the captured image of the target object having the first pattern 71 and the second pattern 72, the captured image having been taken through the predetermined image capturing optical system 20.

In the case of obtaining the first sample image G11, the first sample image area, the second sample image G12, and the second sample image area with oblique incidence illumination on the specimen 50a having the first pattern 71 and the second pattern 72, the orientation of the target object with respect to the predetermined image capturing optical system 20 during capture of the captured image including the first sample image area, and the orientation of the target object with respect to the predetermined image capturing optical system 20 during capture of the captured image including the second sample image area may be substantially identical to each other. Alternatively, the captured image including the first sample image area, and the captured image including the second sample image area may be the same captured image.

Note that the obtaining unit 41 may obtain at least any of the first sample image G11 and the second sample image G12, based on design data for the specimen 50 or design data for the pattern formed on the specimen 50.

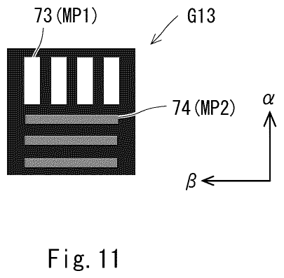

FIG. 11 shows a captured image G13 obtained by the obtaining unit 41 in the image processing device 40 according to the first embodiment. As shown in FIG. 11, the obtaining unit 41 obtains the captured image G13. With the plane of the captured image G13 being adopted as the reference image plane, the captured image G13 includes a third pattern 73 extending in the α-axis direction and a fourth pattern 74 extending in the β-axis direction in the image plane. The captured image G13 is a captured specimen image of a specimen that has the third pattern 73 and the fourth pattern 74. Similar to the first pattern 71, the third pattern 73 is the mask pattern MP1 captured so as to extend in the a-axis direction when the image of the specimen is captured. Similar to the second pattern 72, the fourth pattern 74 is the mask pattern MP2 captured so as to extend in the β-axis direction when the image of the specimen is captured.

As long as predetermined information processing using the first parameter and the second parameter described later can be performed, the pattern widths and the pitch intervals of the first pattern 71 and the third pattern 73 may be identical or different. Likewise, the pattern widths and the pitch intervals of the second pattern 72 and the fourth pattern 74 may be identical or different. Note that the identicalness or difference of the pattern widths and the pitch intervals described here may have a meaning based on comparison of the pattern widths and the pitch intervals of patterns physically formed on the specimen, or a meaning based on comparison of the pattern widths and the pitch intervals of patterns appearing in the specimen image, and patterns drawn as images in the first sample image area and the second sample image area.

The captured image G13 is, for example, a captured image about a specimen on which both a pattern extending at one orientation, and a pattern extending at another orientation different substantially by 90° therefrom on the specimen surface are formed. Note that the pattern extending in the one direction and the pattern extending in the direction different by 90° therefrom may be those formed to have extending orientations different from each other but have physically substantially identical pattern width and pitch interval. Besides, note that the pattern extending in the one direction and the pattern extending in the direction different by 90° therefrom have different physical pattern widths and pitch intervals but may have substantially identical pattern width and pitch interval on the taken image plane, similar to an anamorphic mask. The captured image G13 may be, for example, a captured image of the specimen 50a for the sample image shown in FIG. 6. In this case, the specimen 50a is an object serving as a target subjected to predetermined information processing, such as determination of a defect, and is at the same time the target object for obtaining the first sample image area and the second sample image area. The third pattern 73 is a first pattern, and the fourth pattern 74 is a second pattern. Hereinafter, description is made assuming that the captured image G13 is a captured specimen image of the specimen 50a.

The captured image G13 may include both the third pattern 73 and the fourth pattern 74. The obtaining unit 41 obtains the captured image G13 of the specimen 50a that includes the third pattern 73 and the fourth pattern 74. The obtaining unit 41 may obtain the captured image G13 captured through the image capturing optical system 20 having different NAs for the X-axis direction and the Y-axis direction.

In the case of obtaining the captured image G13 with oblique incidence illumination onto the specimen 50a having the third pattern 73, the obtaining unit 41 may obtain the captured image G13 such that the angle between the direction in which the principal axis of the oblique incidence illumination is projected on the upper surface of the specimen 50a, and the X-axis direction (i.e., the first direction and the α-axis direction) is a predetermined angle. That is, the predetermined image capturing optical system 20 captures an image with oblique incidence illumination on the specimen 50a. The specimen image is a captured image taken through the predetermined image capturing optical system 20 when the angle between the direction in which the principal axis of the oblique incidence illumination is projected on the upper surface of the specimen, and the first direction is the predetermined angle.

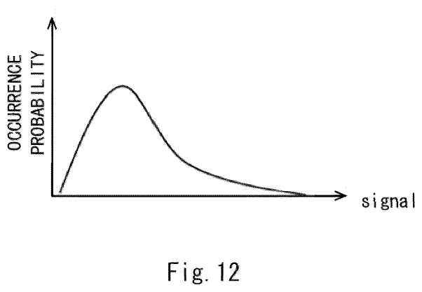

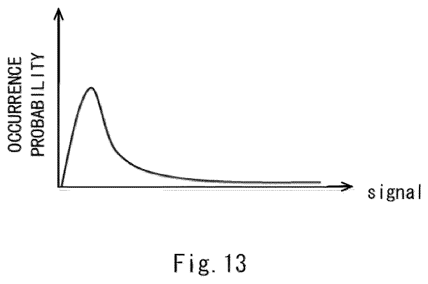

FIGS. 12 and 13 are graphs showing examples of the relationship between the difference signal between predetermined pixels and the occurrence probability in the captured image G13 obtained by the obtaining unit 41 in the image processing device 40 according to the first embodiment, the abscissa axis indicates the difference signal, and the ordinate axis indicates the occurrence probability. FIG. 12 shows the difference signal between predetermined pixels of the third pattern 73 in the captured image G13. FIG. 13 shows the difference signal of the fourth pattern 74 in the captured image G13.

As shown in FIGS. 12 and 13, the occurrence probability of the difference signal of the third pattern 73 ranges more widely than the occurrence probability of the difference signal of the fourth pattern 74. That is, it is indicated that the third pattern 73 is more affected by noise and the like than the fourth pattern. The occurrence probability distribution may thus be created from the histogram of the difference signal obtained from the pattern in each of the α-axis direction and the β-axis direction in the captured image G13. The effect of noise in each direction may be predicted from the created occurrence probability distribution of the difference signal. Thus, the defect detection sensitivity in each direction can be optimized. For example, if the third pattern 73 is more affected by noise and the like than the fourth pattern, a threshold for detecting a defect in the third pattern is more relaxed than that of the fourth pattern.

The setting unit 42 sets a first parameter for the first pattern 71, based on the first sample image area. The first parameter may include a parameter for detecting the first pattern 71, and may include a parameter for detecting a defect in the first pattern 71. As for the first parameter, the setting unit 42 may set the first parameter for the first pattern 71, based on the line edge roughness (hereinafter called LER) distribution in the first sample image area. Note that the setting unit 42 may set the first parameter for the first pattern 71, based not only on the LER distribution in the first sample image area but also on the central luminance, the average luminance, the line width and the like of the first pattern 71 in the first sample image area.

The setting unit 42 may set the first parameter so as to include a threshold used for determination of presence or absence of a defect in the third pattern 73 included in the captured image G13 (the specimen image as described above; this also applies hereafter). Specifically, the setting unit 42 may set the first parameter so as to include a threshold used for a defect inspection for the third pattern 73. Specifically, the setting unit 42 may set the first parameter so as to include a threshold used for a defect inspection based on the luminance difference, for the third pattern 73. The luminance difference includes the difference between the luminance of the first pattern 71 in the first sample image G11, and the luminance of the third pattern 73 in the captured image G13.

The setting unit 42 sets a second parameter for the second pattern 72, based on the second sample image area. The second parameter may include a parameter for detecting the second pattern 72, and may include a parameter for detecting a defect in the second pattern 72. The setting unit 42 may set a second parameter for the second pattern 72, based on the LER distribution in the second sample image area. Note that the setting unit 42 may set the second parameter for the second pattern 72, based not only on the LER distribution in the second sample image area but also on the central luminance, the average luminance, the line width and the like of the second pattern 72 in the second sample image area.

The setting unit 42 may set the second parameter so as to include a threshold used for determination of presence or absence of a defect in the fourth pattern 74 included in the captured image G13 (the specimen image as described above; this also applies hereafter). Specifically, the setting unit 42 may set the second parameter so as to include a threshold used for a defect inspection for the fourth pattern 74. The setting unit 42 may set the second parameter so as to include a threshold used for a defect inspection based on the luminance difference, for the fourth pattern 74. The luminance difference includes the difference between the luminance of the second pattern 72 in the second sample image G12, and the luminance of the fourth pattern 74 in the captured image G13.

The setting unit 42 may set a threshold for a plurality of types of physical quantities for information about the captured image G13. The setting unit 42 may perform setting such that at least an item between the types and number of physical quantities about which the threshold is defined as the first parameter is different from the item of the physical quantities about which the threshold is defined as the second parameter. Preferably, as described above, for example, if the third pattern 73 is more affected by noise and the like than the fourth pattern, a threshold for detecting a defect in the third pattern may be more relaxed than that of the fourth pattern. Accordingly, the setting unit 42 may perform setting such that the number of physical quantities about which the second parameter is set as the threshold used for determination of presence or absence of a defect in the fourth pattern 74 is larger than the number of physical quantities about which the first parameter is set as the threshold used for determination of presence or absence of a defect in the third pattern 73. The physical quantity includes the LER of the pattern, the central luminance of the pattern, the average luminance of the pattern, the line width of the pattern, the luminance difference and the like, and may be selected from such a group.

The processing unit 43 applies predetermined information processing based on the first parameter and the second parameter, to the captured image G13. The predetermined information processing may include predetermined determination, and predetermined image correction. The predetermined determination may include determination of presence or absence of a defect. The processing unit 43 performs predetermined information processing that includes determination of presence or absence of a defect for the third pattern 73 and the fourth pattern 74 included in the captured image G13. The processing unit 43 in this case may be referred to as a determination unit 43a instead of the processing unit 43. The processing unit 43 (determination unit 43a) may perform the predetermined information processing that includes determination of presence or absence of a defect for at least any of the third pattern 73 and the fourth pattern 74 included in the captured image G13.

The processing unit 43 may perform predetermined information processing that includes image correction of the captured image G13 for correcting and alleviating the difference of sensitivities predicted for the third pattern 73 and the fourth pattern 74 included in the captured image G13. The processing unit 43 in this case may be referred to as an image correction unit 43b instead of the processing unit 43. In this case, for example, the setting unit 42 sets the first parameter as a correction value for the luminances of pixels belonging to the third pattern 73 included in the captured image G13, and sets the second parameter as a correction value for the luminances of pixels belonging to the fourth pattern 74 included in the captured image G13. The processing unit 43 (image correction unit 43b) performs predetermined information processing that includes image correction to correct the luminances of at least some of the pixels belonging to the third pattern 73 or the fourth pattern 74 included in the captured image G13, based on such first and second parameters. Note that the setting unit 42 may set the correction value for the luminances of pixels belonging to the third pattern 73 and the fourth pattern 74 by identifying the correction value for the luminances of pixels belonging to the first pattern 71 and the second pattern 72 such that, for example, the LER distribution of the first pattern 71 and the LER distribution of the second pattern 72 can have similar shapes.

For example, if the LER value of the third pattern 73 in the captured image G13 is larger than a threshold set as the first parameter in advance, the determination unit 43a determines that there is a defect in the third pattern 73. If the LER value of the fourth pattern 74 in the captured image G13 is larger than a threshold set as the second parameter in advance, the determination unit 43a determines that there is a defect in the fourth pattern 74.

For example, as shown in FIGS. 2 to 4, even if the image of the same mask pattern MP is captured, the sensitivity may differ depending on the direction on the captured image plane of the mask pattern MP. Depending on such a difference in sensitivity, a threshold for LER as the first parameter for the pattern extending at the first orientation, and a threshold for LER as the second parameter for the pattern extending at the second orientation may be different from each other. A threshold for an edge captured as a rough image as in FIG. 3 is rougher than a threshold for an edge captured as a smooth image as in FIG. 4. By causing the setting unit 42 to inspect a specimen based on a threshold set in advance for each orientation where the pattern extends, erroneous determination, such as determination that what appears a rough edge but is not a defect as a defect, and determination that a defect that appears not to be a defect because it appears to be a smooth edge is overlooked, can be prevented.

If the pattern extending in the first direction and the pattern extending in the second direction different by 90° therefrom on the specimen 50 are formed to have physically substantially identical pattern widths and pitch intervals, the setting unit 42 sets the first parameter and the second parameter (e.g., thresholds for determining a defect) for each direction in which the pattern extends. Accordingly, determination in consideration of, for example, the difference in resolution due to the difference in NA can be achieved. Similar to an anamorphic mask, if the specimen 50 is a specimen formed such that the physical pattern widths and pitch intervals differ between the pattern extending in the first direction and the pattern extending in the second direction different by 90° therefrom, but the pattern widths and pitch intervals of them appear to be substantially identical on a captured image plane, the setting unit 42 sets the first parameter and the second parameter (e.g., thresholds for determining a defect) for each direction in which the pattern extends. Accordingly, determination in consideration of, for example, the difference in resolution due to the difference in the orientation of the pattern can be achieved.

### <Image Processing Method>

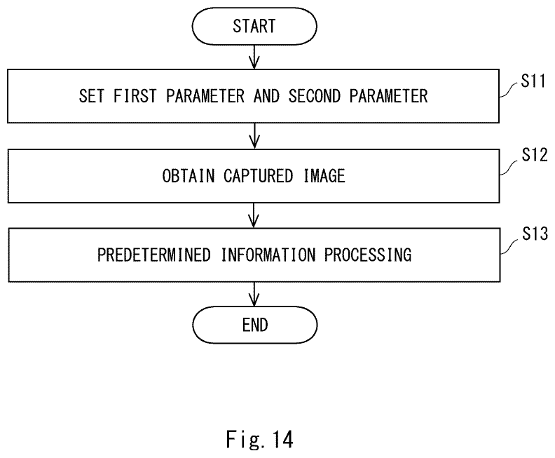

Next, an image processing method using the image processing device according to the present embodiment is described. FIG. 14 is a flowchart showing an example image processing method using the image processing device according to the first embodiment. As shown in step S11 of FIG. 14, the first parameter and the second parameter are set. Specifically, the setting unit 42 sets the first parameter for the first pattern 71, based on the first sample image area. The setting unit 42 sets a second parameter for the second pattern 72, based on the second sample image area.

Here, as described above, the setting unit 42 may set the first parameter and the second parameter, based on the first sample image area and the second sample image area included in images obtained by causing the oblique incidence illumination onto the target object having the first pattern to have angles from the direction in which the first pattern extends is 0° and 90°. The setting unit 42 may set the first parameter and the second parameter, based on the first sample image area and the second sample image area included in an image obtained without changing the angle of the oblique incidence illumination onto the object having the first pattern and the second pattern from the direction in which the first pattern extends. Alternatively, the setting unit 42 may set the first parameter and the second parameter, based on the first sample image area and the second sample image area generated based on design data for the target object having the first pattern or the target object having the first pattern and the second pattern.

For setting of the first parameter, the setting unit 42 may set the first parameter to include a threshold used for determination of presence or absence of a defect in the third pattern included in the captured image G13. For setting of the second parameter, the setting unit 42 may set the second parameter to include a threshold used for determination of presence or absence of a defect in the fourth pattern included in the captured image G13.

Next, as indicated in step S12, the captured image G13 is obtained. Specifically, the obtaining unit 41 obtains the captured image G13 of the specimen 50a that includes the third pattern 73 and the fourth pattern 74. The captured image G13 may include both the third pattern 73 and the fourth pattern 74, or may include at least any of the third pattern 73 and the fourth pattern 74.

Next, as indicated in step S13, predetermined information processing is performed. Specifically, the processing unit 43 applies the predetermined information processing based on the first parameter and the second parameter to the captured image G13. As an execution of the predetermined information processing, the processing unit 43 may perform predetermined information processing that includes determination of presence or absence of a defect for the third pattern 73 and the fourth pattern 74 included in the captured image G13. Alternatively, as an execution of the predetermined information processing, the processing unit 43 may perform the predetermined information processing that includes image correction of the captured image G13.

### <Inspection Method>

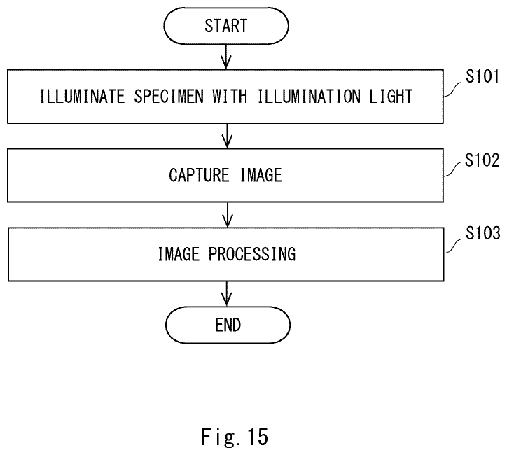

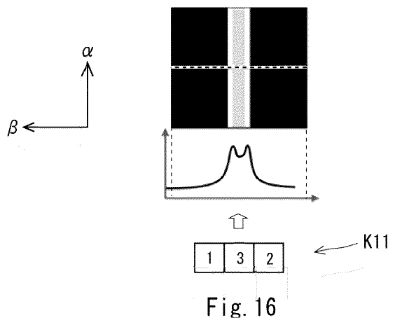

Next, an inspection method is described as an operation of the inspection apparatus 1 in the present embodiment. FIG. 16 is a flowchart showing an example inspection method using the inspection apparatus 1 according to the first embodiment. As indicated in step S101 of FIG. 15, first, the specimen 50 is illuminated with the illumination light L11. For example, in a case in which the specimen 50 is illuminated with the illumination light L11 generated by the light source 11, the illumination optical system 10 is disposed so as to achieve critical illumination. The specimen 50 is illuminated with the illumination light L11.

Next, as indicated in step S102, an image of the specimen 50 is captured. For example, the image capturing optical system 20 captures a captured image of the specimen 50 illuminated with the illumination light L11. The image capturing optical system 20 outputs the captured image G13 of the specimen 50, as a detection result of the detector 23, to the image processing device 40.

Next, as indicated in step S103, the image processing device 40 applies image processing to the captured image G13. Specifically, the image processing device 40 sets the first parameter, the second parameter and the like, as in the image processing method described above. The image processing device 40 applies predetermined information processing to the captured image obtained from the image capturing optical system 20.

Next, advantageous effects of the present embodiment are described. The image processing device 40 in the present embodiment sets the first parameter for the first pattern 71, and the second parameter for the second pattern 72. Accordingly, the parameters can be independently adjusted in the α-axis direction and the β-axis direction. Consequently, appropriate measures can be taken to address the difference in sensitivity due to the pattern image capturing direction.

Since the parameters are set in advance for the first pattern 71 and the second pattern 72, the effect of the difference in resolution in each direction can be preliminarily predicted.

For example, based on the first sample image G11 and the second sample image G12, thresholds of determining a defect can be set for parameters, such as the LER, luminance, line width and the like. Consequently, defect determination can be appropriately performed for the difference in sensitivity due to the pattern image capturing direction. For example, thresholds used to perform defect determination of LER in the first pattern 71 and the second pattern 72 can be independently set in the α-axis direction and the β-axis direction. Accordingly, the effect of LER and the like can be predicted, and the defect detection sensitivity can be optimized.

Actually captured images may be used as the first sample image G11 and the second sample image G12. In this case, the parameter accuracies can better align with the actually captured image G13. The first sample image G11 and the second sample image G12 may be obtained by performing an optical simulation where the design pattern of the mask and the NA of a focusing optical system are adopted as input. Accordingly, efforts of actually capturing images can be omitted, and the parameter can be made to approach ideal values.

The present embodiment is more effective in addressing the varying appearance due to the illumination direction and the characteristics of the image capturing optical system 20, as with oblique incidence illumination making EUV light obliquely incident. The specimen 50 may include an anamorphic mask used by the image capturing optical system 20 that has different magnifications between the X-axis direction and the Y-axis direction. A high-NA mask, such as an anamorphic mask, may have the line width in the X-axis direction and the line width in the Y-axis direction, which are different from each other. By applying the present embodiment to such a specimen 50, the defect detection sensitivity can be more optimized. The obtaining unit 41 may obtain a captured image G13 that has the different numbers of pixels for binning between the X-axis direction and the Y-axis direction. Such a captured image G13 also has a difference in sensitivity due to the pattern image capturing direction. Accordingly, by applying the present embodiment, appropriate measures can be taken. It is not necessary that a single device includes all the components, such as the obtaining unit 41, the setting unit 42, and the processing unit 43. For example, the image processing device may be configured by implementing the obtaining unit 41, the setting unit 42, and the processing unit 43 separately in two or more devices, such as an optical apparatus and a server apparatus, and causing the devices to communicate and cooperate. The image processing device may be configured to function as the obtaining unit 41, the setting unit 42, and the processing unit 43 by causing the two or more devices, such as an optical apparatus and a server apparatus, to communicate and cooperate.

### Second Embodiment

Next, an image processing device 40 according to a second embodiment is described. The present embodiment uses an image conversion parameter, such as a kernel. The image processing device 40 in the present embodiment also has a configuration similar to that of the image processing device 40 in the first embodiment, and includes an obtaining unit 41, a setting unit 42, and a processing unit 43.

The obtaining unit 41 obtains a specimen image that is a captured image of a specimen 50 taken through a predetermined image capturing optical system 20.

The setting unit 42 sets an image conversion parameter, based on a first sample image area that is an area including a first pattern extending in a first direction on a reference image plane, and a second sample image area that is an area including a second pattern extending in a second direction on the reference image plane. Here, the image conversion parameter includes, for example, a one-dimensional kernel, a two-dimensional kernel and the like. Hereinafter, the one-dimensional kernel and the two-dimensional kernel are used as examples of the image conversion parameter, and description is made. Note that the image conversion parameter is not limited to the one-dimensional kernel, the two-dimensional kernel and the like, and may include, for example, the first parameter and the second parameter described above. Note that the first sample image area and the second sample image area may be obtained by capturing an image of a target object by the obtaining unit 41, or obtained by capturing an image of the specimen 50.

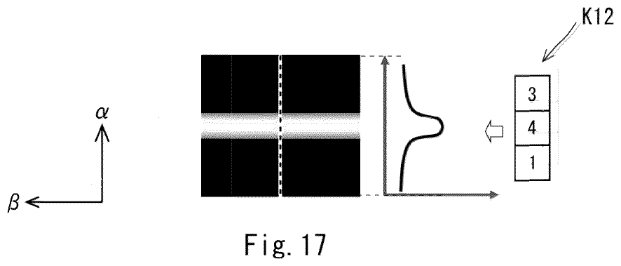

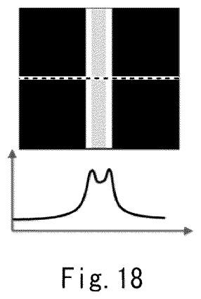

FIG. 16 shows an example first pattern extending in the first direction, an example luminance distribution along the second direction in the first pattern, and an example one-dimensional kernel K11 applied to the luminance distribution in the image processing device 40 according to the second embodiment. FIG. 17 shows an example second pattern extending in the second direction, an example luminance distribution along the first direction in the second pattern, and an example one-dimensional kernel K12 applied to the luminance distribution in the image processing device 40 according to the second embodiment. FIG. 18 shows an example luminance distribution in a reference shape along a direction orthogonal to the pattern extending direction in the image processing device 40 according to the second embodiment.

As shown in FIG. 16, the one-dimensional kernel K11 may correspond to the luminance distribution along the second direction in the first pattern extending in the first direction. The luminance distribution along the second direction in the first pattern may be referred to as a first luminance distribution. The one-dimensional kernel K11 may include parameters, such as a vector arranged in the second direction or matrix elements. The one-dimensional kernel K11 is an image conversion parameter that converts the first luminance distribution shown in FIG. 16 so as to resemble a luminance distribution having a reference shape shown in FIG. 18.

For example, the setting unit 42 sets the one-dimensional kernel K11 that includes components of a moving average filter and components of a sharpening filter. Here, the moving average filter is a filter that smooths the luminance distribution. The sharpening filter is a filter that sharpens the luminance distribution. The setting unit 42 sets the parameters of the one-dimensional kernel K11 by adjusting the ratio of the components of the moving average filter and the ratio of the components of the sharpening filter. The setting unit 42 sets the parameters of the one-dimensional kernel K11 such that the first luminance distribution resembles the luminance distribution having the reference shape.

As shown in FIG. 17, the one-dimensional kernel K12 may correspond to the luminance distribution along the first direction in the second pattern extending in the second direction. The luminance distribution along the first direction in the second pattern may be referred to as a second luminance distribution. The one-dimensional kernel K12 may include parameters, such as a vector arranged in the first direction or matrix elements. The one-dimensional kernel K12 is an image conversion parameter that converts the second luminance distribution shown in FIG. 17 so as to resemble a luminance distribution having a reference shape shown in FIG. 18. Note that in this case, the luminance distribution having the reference shape shown in FIG. 18 is the distribution obtained by 90° rotation to achieve the luminance distribution along the first direction. However, in the following description, for the sake of simplicity, the description of 90° rotation may be omitted.

For example, the setting unit 42 sets the one-dimensional kernel K12 that includes components of a moving average filter and components of a sharpening filter. The setting unit 42 sets the parameters of the one-dimensional kernel K12 by adjusting the ratio of the components of the moving average filter and the ratio of the components of the sharpening filter. The setting unit 42 sets the parameters of the one-dimensional kernel K12 such that the second luminance distribution resembles the luminance distribution having the reference shape. For example, the setting unit 42 may increase the components of the sharpening filter so as to be larger than the components of the moving average filter such that the second luminance distribution in FIG. 17 resembles the luminance distribution having the reference shape in FIG. 18.

The luminance distribution having the reference shape shown in FIG. 18 may be a luminance distribution along a direction orthogonal to the pattern extending direction in the pattern included in the reference image, or a luminance distribution obtained through an optical simulation. The first luminance distribution shown in FIG. 16 or the second luminance distribution shown in FIG. 17 may be the luminance distribution having the reference shape.

Note that the setting unit 42 may set the one-dimensional kernel K11 and the one-dimensional kernel K12 without using the luminance distribution having the reference shape. For example, the setting unit 42 may set the one-dimensional kernel K11 and the one-dimensional kernel K12 such that the luminance distribution in a case of applying the one-dimensional kernel K11 to the first luminance distribution shown in FIG. 16 is similar to the luminance distribution in a case of applying the one-dimensional kernel K12 to the second luminance distribution shown in FIG. 17. Note that in this case, the distribution is obtained by rotating any luminance distribution by 90°.

For example, the setting unit 42 changes at least one of the parameters of the one-dimensional kernel K11 and the one-dimensional kernel K12 so as to minimize the luminance difference of each pixel between the luminance distribution in the case of applying the one-dimensional kernel K11 to the first luminance distribution shown in FIG. 16 and the luminance distribution in the case of applying the one-dimensional kernel K12 to the second luminance distribution shown in FIG. 17. The setting unit 42 may set the one-dimensional kernel K11 and the one-dimensional kernel K12 so as to include parameters in a case in which the luminance difference of each pixel between both the distributions is the minimum.

In the aspect described above as the example, the luminance distribution obtained by applying the one-dimensional kernel K11 set by the setting unit 42 to the luminance distribution along the second direction in the first pattern extending in the first direction, and the luminance distribution obtained by applying the one-dimensional kernel K12 to the luminance distribution along the first direction in the second pattern extending in the second direction have shapes similar to each other.

Note that the application of the one-dimensional kernels K1l and K12 to the luminance distribution may mean application of a convolution process by the one-dimensional kernels K11 and K12 to the pixels constituting the luminance distribution. The convolution process by the one-dimensional kernels K11 and K12 may conform to a convolution process by a two-dimensional kernel K21, a kernel W or the like described later.

The setting unit 42 sets the two-dimensional kernel K21 having two-dimensional parameters corresponding to the first direction and the second direction. That is, the setting unit 42 sets the two-dimensional kernel K21 as the image conversion parameters. The setting unit 42 sets the two-dimensional kernel K21, based on the one-dimensional kernel K11 and the one-dimensional kernel K12. Specifically, the setting unit 42 may set the two-dimensional kernel K21, from the product of the vector that is the one-dimensional kernel K11 and the vector that is the one-dimensional kernel K12. That is, provided that the one-dimensional kernel K12 is a column vector (b1, b2, . . . , bn) and one-dimensional kernel K11 is a row vector (a1, a2, . . . , an), the two-dimensional kernel K21 may be set by obtaining an n×n matrix based on each product of elements. Here, Cij that is the i-th on the column and j-th on the row component of the two-dimensional kernel K21 is bixaj. Note that the setting unit 42 may set the two-dimensional kernel K21, from the cross product of the one-dimensional kernel K11 and the one-dimensional kernel K12. In addition, if the setting unit 42 can set the two-dimensional kernel K21 using the one-dimensional kernel K11 and the one-dimensional kernel K12, this unit may set the two-dimensional kernel K21 by a calculation method other than the product or the cross product.

The two-dimensional kernel K21 may have distribution modes of the two-dimensional parameters that are asymmetric between the first direction and the second direction. Such a two-dimensional kernel K21 can be, for example, a kernel set in consideration of the difference in sensitivity between the vertical direction and the horizontal direction (the first direction and the second direction in the reference image plane). That is, some optical apparatuses may have sensitivities different between the first direction and the second direction. Accordingly, to alleviate the difference between the sensitivity in the first direction and the sensitivity in the second direction, the setting unit 42 sets the kernel K21 that has a parameter distribution mode asymmetric between the first direction and the second direction. Consequently, the parameter distribution mode in the two-dimensional kernel K21 is asymmetric between the first direction and the second direction. The two-dimensional kernel K21 is an example of a kernel set in consideration of the difference in sensitivity between the vertical direction and the horizontal direction. In other words, the two-dimensional kernel K21 is an example of a kernel set so as to alleviate the difference in sensitivity between the vertical direction and the horizontal direction.

The processing unit 43 performs predetermined information processing of applying an image conversion parameter, such as the two-dimensional kernel K21, for a specimen image, or an image based on the specimen image. The two-dimensional kernel K21 may be simply referred to as a kernel W. As described above, the processing unit 43 performs the predetermined information processing of applying the kernel W in order to alleviate the difference in aspects of images taken at sensitivities different between the first direction and the second direction.

Hereinafter, <Process of applying kernel to specimen image> is described as the predetermined information processing. Subsequently, <Defect inspection> is described. In <Modification example 1 of second embodiment>, <Kernel parameter setting based on difference image> is described. Subsequently, <Process of applying kernel to specimen image> is described as the predetermined processing. Furthermore, in <Modification example 2 of second embodiment>, as the predetermined information processing, <Process of applying kernel to difference Image> is described, and <Defect inspection> is described. Moreover, in <Modification example 3 of second embodiment>, processes of using a corrected specimen image and a corrected difference image are described as the predetermined information processing. Note that the image based on the specimen image includes the difference image, the corrected specimen image, and the corrected difference image.

### <Process of Applying Kernel to Specimen Image>

The processing unit 43 applies the kernel W having the distribution mode of the parameters set by the setting unit 42 to the specimen image and outputs the corrected specimen image, as the predetermined information processing. The kernel W to be applied to the specimen image may be referred to as a first kernel W.

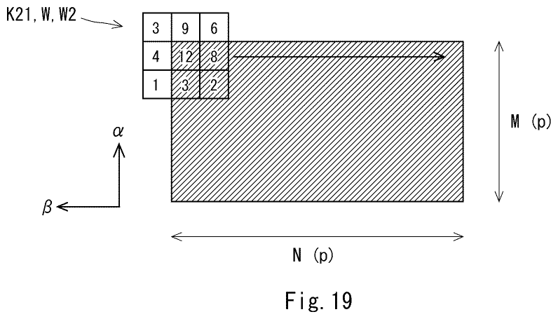

FIG. 19 is a schematic diagram showing example information processing performed for the specimen image or an image based on the specimen image by the processing unit 43 in the image processing device 40 according to the second embodiment. As shown in FIG. 19, the processing unit 43 may perform the predetermined information processing of applying the kernel W to the specimen image.

When the reference image plane is laid on the specimen image, the specimen image is an image that includes a plurality of pixel arrays arranged in the first direction, and a plurality of pixel arrays arranged in the second direction. Here, the specimen image is an image that includes M pixels p arranged in the first direction, and N pixels p arranged in the second direction.

The first kernel W having two-dimensional parameters set by the setting unit 42 is, for example, a kernel that includes three rows and three columns, i.e., 3×3=9 cells. The size of each element (may be referred to as cell) of the first kernel W may virtually correspond to the size of the pixel p of the specimen image.

The predetermined information processing may be, for example, the convolution process described in Non Patent Literature 1. That is, the processing unit 43 may perform the convolution process of applying the first kernel W to the specimen image. Specifically, at a pixel p corresponding to the center of the first kernel W, between the peripheral 3×3 pixel values (for example, luminances) and the parameters of the first kernel W, the convolution process is performed, and each pixel in the specimen image is filtered. For example, each cell of the first kernel W is represented as (i, j) using local coordinate axes including x- and y-axes. Provided that a local operator for performing image filtering is J (p) at peripheral 3×3 of each pixel p, J(p) can be defined by the following expression (1) as convolution between the luminance value I(x+i, y+j) around pixel p=(x, y) and W′(p) on the specimen image (convolution is a two-dimensional discrete approximation).

$$\begin{matrix}[ Mathematical formula 1 ] & \\ J ( p ) = I * {W}^{′} ( p ) = \frac{1}{S} {\sum }_{i = - k}^{k} {\sum }_{j = - k}^{k} {w}_{i , j}^{′} \cdot I ( x + i , y + j ) & ( 1 )\end{matrix}$$

Here, W′(p) is a kernel obtained by inverting the original first kernel W(p) with respect to both the x- and y-axes, which are the local coordinate axes. w′_{i,j} is a weighting coefficient at each position (i, j) of the inverted kernel W′(p), and S>0 is a coefficient for normalization and scaling. If i and j exceed the boundary range of the specimen image, a padding process may be preliminarily performed, and a pixel value I(x+i, y+j) filled with values at the periphery may be used. Thus, the processing unit 43 performs the convolution process for each pixel of the specimen image, and outputs the processed pixel value. The processing unit 43 can sweep the entire specimen image with the first kernel W by sequentially changing the pixel of the specimen image where the center cell of the first kernel W is disposed. Accordingly, the processing unit 43 obtains the corrected specimen image where the first kernel W has been applied to the entire specimen image.

Similar to the specimen image, the corrected specimen image is an image that includes M pixels arranged in the first direction, and N pixels arranged in the second direction. The luminance I′_{m,n} at each pixel (p′_{m,n}) of the corrected specimen image is changed by applying the first kernel W from luminance I_{m,n} of each pixel (p_{m,n}) of the specimen image. The corrected specimen image is an image obtained by applying the first kernel W having a parameter distribution different between the first direction and the second direction to the specimen image, and outputting it. Consequently, the corrected specimen image is an image having a more alleviated difference in sensitivity in the first direction and the second direction than the specimen image.

### <Defect Inspection>

The processing unit 43 detects a defect, based on the difference image between the reference image and the corrected specimen image. The reference image may be a good quality image, such as an image with no abnormality or an image with no critical abnormality. The difference image may include the difference in luminance between pixels at the same relative position among the pixels of the reference image and the pixels of the corrected specimen image, as a parameter for the pixel. The difference image may include the ratio of luminance between pixels having the same relative position among the pixels of the reference image and the pixels of the corrected specimen image, as a parameter for the pixel. Hereinafter, the parameter of the pixel of the difference image is simply referred to as luminance. The processing unit 43 may detect a defect, based on whether the luminance of the pixel included in the difference image exceeds a predetermined threshold or not.

### Modification Example 1 of Second Embodiment

### <Kernel Parameter Setting Based on Difference Image>

The setting unit 42 may set the image conversion parameter on the basis of an image based on comparison between the captured image of the target object and the reference image for the captured image, or an image based on comparison between the specimen image that is the captured image of the specimen and the reference image for the specimen image.

Description is hereinafter made assuming that the setting unit 42 sets the image conversion parameter on the basis of the image based on comparison between the captured image of the target object and the reference image for the captured image. The image based on comparison between the captured image of the target object and the reference image for the captured image is, for example, the difference image between the captured image and the reference image. The reference image may be a good quality image, such as an image with no abnormality or an image with no critical abnormality. The difference image may include the difference in luminance between pixels at the same relative position among the pixels of the reference image and the pixels of the captured image of the target object, as a parameter for the pixel. The difference image may include the ratio of luminance between pixels at the same relative position among the pixels of the reference image and the pixels of the captured image, as a parameter for the pixel. Hereinafter, the parameter of the pixel of the difference image is simply referred to as luminance.

As described later, in a modification example 1 of the second embodiment, the target object and the specimen 50 do not necessarily have a pattern formed to extend in one direction. In other words, the target object and the specimen 50 may have no pattern formed extending in one direction. Due to increase in complexity of the semiconductor structure in recent years, not only a pattern extending in one direction and a pattern extending in the direction perpendicular to the one direction but also patterns having various shapes, such as a pattern having a curved shape, an obliquely extending pattern, and a contact hole, can be formed on the specimen 50, such as a photomask or a wafer. Here, according to the modification example 1 of the second embodiment, irrespective of the shape and type of the pattern formed on the target object or the specimen 50, the setting unit 42 can set the image conversion parameter in consideration of the difference in NA or the difference in sensitivity between the vertical direction and the horizontal direction.

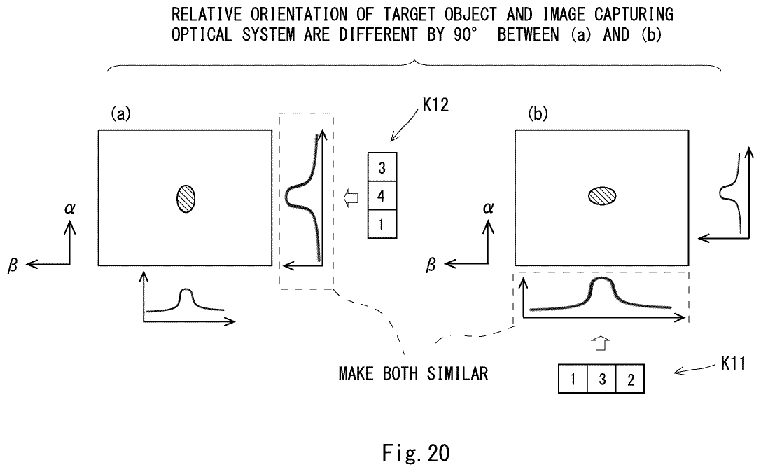

FIG. 20 shows example difference images in the image processing device 40 according to the modification example 1 of the second embodiment. A difference image (a) in FIG. 20 indicates a luminance distribution along the first direction, and a difference image (b) indicates a luminance distribution along the second direction. As shown in FIG. 20, the setting unit 42 sets the one-dimensional kernel K12 for the difference image (a) between the captured image, captured when the relative orientation of the target object and the image capturing optical system is a predetermined orientation, and the reference image for the captured image. An area having a luminance exceeding a predetermined threshold in the difference image is referred to as a defect area. A luminance distribution in the case of applying the one-dimensional kernel K12 to the luminance distribution along the first direction with the plane of the difference image (a) including the defect area being adopted as the reference image plane is referred to as a third luminance distribution. The image capturing optical system has NA different between the first direction and the second direction orthogonal to the first direction, with the captured image being adopted as the reference image plane. Additionally or alternatively, the image capturing optical system may have an imaging magnification different between the first direction and the second direction orthogonal to the first direction, with the captured image being adopted as the reference image plane.

The setting unit 42 sets the one-dimensional kernel K11 for the difference image (b) between the captured image captured when the relative orientation of the target object and the image capturing optical system is an orientation different by 90° from the predetermined orientation, and the reference image for the captured image. An area corresponding to the defect area in the difference image (b) is referred to as a rotated defect area. A luminance distribution in the case of applying the one-dimensional kernel K11 to the luminance distribution along the second direction with the plane of the difference image (b) including the rotated defect area being adopted as the reference image plane is referred to as a fourth luminance distribution. Note that the second direction is, for example, a direction different by 90° from the first direction.

The setting unit 42 sets the one-dimensional kernel K11 and the one-dimensional kernel K12 such that the third luminance distribution and the fourth luminance distribution are similar to each other.

As described above, the setting unit 42 sets the one-dimensional kernel K11 and the one-dimensional kernel K12 such that the luminance distribution in the case of applying the one-dimensional kernel K12 to the luminance distribution, along the first direction, of the area having a luminance exceeding a predetermined threshold (hereinafter referred to as a defect area), with the plane of the difference image being adopted as the reference image plane, in the difference image between the captured image when the relative orientation between the target object and the image capturing optical system is a predetermined orientation, and the reference image for the captured image, and the luminance distribution in the case of applying the one-dimensional kernel K11 to the luminance distribution, along the second direction different by 90° from the first direction, of the rotated defect area that is an area corresponding to the defect area, with the plane of the difference image being adopted as the reference image plane, in the difference image between the captured image when the relative orientation of the target object and the image capturing optical system is an orientation different by 90° from the predetermined orientation, and the reference image for the captured image, can be similar to each other. The defect area may be appropriately referred to as an area of interest.

It is herein conceivable that the difference in the luminance distribution in the defect area between the first direction and the second direction in the difference images (a) and (b) is caused not only by the difference in NA, or the difference in magnification or sensitivity between the vertical direction and the horizontal direction, but also by the shape of the defect area (longitudinal in the α direction in FIG. 20). Accordingly, the setting unit 42 sets the image conversion parameter, based on the luminance distributions in the first direction and the second direction in the defect areas in the difference images with the relative orientation of the target object and the image capturing optical system being different by 90° from each other. Consequently, the difference in luminance distribution caused by the shape of the defect area can be minimized, and the appropriate image conversion parameter can be set.

The setting unit 42 may set the one-dimensional kernel K11 and the one-dimensional kernel K12 such that both the luminance distribution in a case of applying the one-dimensional kernel K12 to the luminance distribution along the first direction in the defect area, and the luminance distribution in a case of applying the one-dimensional kernel K11 to the luminance distribution along the second direction in the rotated defect area can be similar to the luminance distribution having a reference shape. The setting unit 42 may set the one-dimensional kernel K11 and the one-dimensional kernel K12 without using the luminance distribution having the reference shape, and for example, may set the one-dimensional kernel K11 and the one-dimensional kernel K12 such that one has a luminance distribution similar to that of the other. Alternatively, the setting unit 42 may set the one-dimensional kernel K11 and the one-dimensional kernel K12 so as to minimize the luminance difference between pixels between the luminance distributions obtained by applying the corresponding one-dimensional kernels to the respective luminance distributions, by changing the parameter of at least any of the one-dimensional kernel K11 and the one-dimensional kernel K12.

The setting unit 42 may set the two-dimensional kernel K21, based on the one-dimensional kernel K11 and the one-dimensional kernel K12. Specifically, the setting unit 42 may set the two-dimensional kernel K21, from the product of the vector that is the one-dimensional kernel K11 and the vector that is the one-dimensional kernel K12. Note that the setting unit 42 may set the two-dimensional kernel K21, from the cross product of the one-dimensional kernel K11 and the one-dimensional kernel K12. In addition, if the setting unit 42 can set the two-dimensional kernel K21 using the one-dimensional kernel K11 and the one-dimensional kernel K12, this unit may set the two-dimensional kernel K21 by a calculation method other than the product or the cross product.

The two-dimensional kernel K21 set based on the difference image by the setting unit 42 as described above can be regarded as an example of a kernel set in consideration of the difference in NA and difference in magnification or sensitivity between the vertical direction and the horizontal direction, in other words, a kernel set so as to alleviate the difference in NA and difference in magnification or sensitivity between the vertical direction and the horizontal direction.

### <Process of Applying Kernel to Specimen Image>

The processing unit 43 applies the kernel W having the distribution mode of the parameters set by the setting unit 42 to the specimen image and outputs the corrected specimen image, as the predetermined information processing. That is, the processing unit 43 may output the corrected specimen image by applying, to the specimen image, the two-dimensional kernel K21 that is the image conversion parameter set by the setting unit 42 on the basis of the image based on comparison between the captured image of the target object and the reference image for the captured image. The two-dimensional kernel K21 at this time is the kernel W to be applied to the specimen image. Accordingly, this kernel is an example of the first kernel W.

As described above, the specimen 50 to be subjected to predetermined information processing, such as determination of presence or absence of a defect, and the target object may be the same object or a different object.

In the present modification example 1, the target object and the specimen 50 may have no pattern formed extending in one direction. This is because in the present modification example 1, the image conversion parameter is set based on the defect area in the difference image, and here, the defect area in the difference image can occur irrespective of the shape or type of the pattern.

### Modification Example 2 of Second Embodiment

### <Process of Applying Kernel to Difference Image>

The processing unit 43 may apply, to the difference image, a kernel having a parameter distribution set by the setting unit 42, and output the corrected difference image, as the predetermined information processing. The reference image may be a good quality image, such as an image with no abnormality or an image with no critical abnormality. The difference image may include the difference in luminance between pixels at the same relative position among the pixels of the reference image and the pixels of the corrected specimen image, in a parameter for the pixel. The difference image may include the ratio of luminance between pixels having the same relative position among the pixels of the reference image and the pixels of the corrected specimen image, in a parameter for the pixel. Alternatively, the difference image may include the difference in luminance between pixels at the same relative position among the pixels of the reference image and the pixels of the specimen image, in a parameter for the pixel. The difference image may include the ratio of luminance between pixels having the same relative position among the pixels of the reference image and the pixels of the specimen image, in a parameter for the pixel.

Here, as described in the second embodiment, the kernel applied to the difference image may be a kernel set by the setting unit 42, based on the first sample image area that is an area including the first pattern extending in the first direction on the reference image plane, and the second sample image area that is an area including the second pattern extending in the second direction orthogonal to the first direction on the reference image plane. Alternatively, as described in the modification example 1 of the second embodiment, the kernel applied to the difference image may be a kernel set by the setting unit 42 on the basis of an image based on comparison between the captured image of the target object (or the specimen) and the reference image for the captured image. In this case, the target object and the specimen 50 may have no pattern formed extending in one direction. The kernel to be applied to the difference image may be referred to as a second kernel W2.

When the reference image plane is laid on the difference image, the difference image may be an image that includes a plurality of pixel arrays arranged in the first direction, and a plurality of pixel arrays arranged in the second direction. Here, the difference image is assumed as an image that includes M pixels arranged in the first direction, and N pixels arranged in the second direction. The size of each cell of the second kernel W2 virtually corresponds to the size of the pixel of the difference image. Thus, according to a process similar to the process in the case of applying the first kernel W to the entire specimen image described above, the processing unit 43 can obtain the corrected difference image by applying the second kernel W2 to the entire difference image.

Similar to the difference image, the corrected difference image is an image that includes M pixels arranged in the first direction, and N pixels arranged in the second direction. The luminance I′″_{m,n} at each pixel (p′″_{m,n}) of the corrected difference image is changed by applying the second kernel W2, from the luminance I″_{m,n} of each pixel (p″_{m,n}) of the difference image. The corrected difference image is an image obtained by applying the second kernel W2 having a parameter distribution different between the first direction and the second direction to the difference image, and outputting it. Consequently, the corrected difference image is an image having a more alleviated difference in sensitivity in the first direction and the second direction than the difference image.

### <Defect Inspection>

The processing unit 43 detects a defect, based on the corrected difference image. The processing unit 43 may detect a defect based on whether the luminance of the pixel included in the corrected difference image exceeds a predetermined threshold or not.

### Modification Example 3 of Second Embodiment

The processing unit 43 may perform, as the predetermined information processing, that obtains the corrected difference image obtained by applying the first kernel W to the specimen image, and obtains the corrected difference image obtained by applying the second kernel W2 to the difference image between the reference image (that may be a good quality image corresponding to the specimen image, or an image obtained by applying the first kernel W to the good quality image), and the corrected specimen image. Furthermore, the processing unit 43 may detect a defect, based on the corrected difference image.

Here, in a case in which a specific defect image is included in the difference image between the corrected specimen image and the reference image, the processing unit 43 may obtain a corrected difference image obtained by applying the second kernel W2 to the difference image. That is, in the case in which the specific defect image is included in the difference image between the corrected specimen image and the reference image, the processing unit 43 may evaluate the specimen 50, based on the corrected difference image obtained by applying the second kernel W2 to the difference image. On the other hand, in the case in which no specific defect image is included in the difference image between the corrected specimen image and the reference image, the processing unit 43 may evaluate the specimen 50, based on the difference image. The case in which the specific defect image is included may include, for example, a case in which pixels having luminances exceeding a predetermined threshold reside over predetermined areas in the difference image.

Here, the setting unit 42 may allow the first kernel W and the second kernel W2 to be an identical kernel. The setting unit 42 may allow the first kernel W and the second kernel W2 to be a different kernel. As for the first kernel W, as described above, the setting unit 42 may set the first kernel W so as to have a parameter distribution where the distribution is asymmetric between the first direction and the second direction, based on the first sample image area that is an area including the first pattern extending in the first direction on the reference image plane, and the second sample image area that is an area including the second pattern extending in the second direction orthogonal to the first direction on the reference image plane (second embodiment). Alternatively, the setting unit 42 may set the first kernel W so as to have a parameter distribution having a distribution asymmetric between the first direction and the second direction, based on the defect area in the difference image between the captured image of the target object (or the specimen 50) and the reference image (the modification example 1 of the second embodiment). On the other hand, the setting unit 42 may set the second kernel W2 by a method according to a thought and a purpose different from those described above, as described later. That is, the first kernel W may be a kernel set in consideration of the difference in sensitivity between the vertical direction and the horizontal direction. On the other hand, the second kernel W2 may be a kernel set for working effects different from those.

For example, the setting unit 42 may set the parameter of the second kernel W2, based on the transferability of a defect on the specimen, as follows. That is, the second kernel W2 may be set in consideration of the transferability of a foreign matter, such as a defect, during exposure.

### <Second Kernel Setting Method>

For example, the specimen image, and an image of a substrate, such as a wafer, (referred to as a substrate image) on which a pattern has been formed with the specimen is being assumed as a patterning device, are prepared. The setting unit 42 sets the parameter of the kernel W such that the specimen image applied by the kernel W can be similar to the substrate image. Note that when the setting unit 42 sets the parameter of the kernel W, this unit may set the parameter of the kernel W, based on a learning model achieved by training with a plurality pairs of the specimen image and the substrate image being assumed as training data. The setting unit 42 may preliminarily derive the substrate image from the specimen image using the optical simulation, and set the kernel W, which can produce a result equivalent to the simulated substrate image when applied to the specimen image. The setting unit 42 may set the parameter of the second kernel W2 for application to the difference image, based on the parameter of the kernel W derived based on the specimen image according to the aspect described above as the example. Such a kernel may be an example of a kernel set in consideration of the transferability of a foreign matter during exposure.

### <Predetermined Information Processing>

The processing unit 43 may obtain the corrected specimen image through predetermined information processing that applies the first kernel W1 to the specimen image, and may obtain the corrected difference image that applies the second kernel W2 to the difference image between the reference image and the corrected specimen image. Furthermore, the processing unit 43 may detect a defect, based on the corrected difference image. Here, the first kernel W is a kernel set in consideration of the difference in sensitivity between the vertical direction and the horizontal direction as described above. The second kernel W is the second kernel W2 set in consideration of the transferability of a foreign matter during exposure as described above.

As described above, for analysis of the specimen image, an appropriate inspection in consideration of the difference in sensitivity between the vertical direction and the horizontal direction and the transferability of a foreign matter during exposure can be achieved by applying the kernel (first kernel W) set in consideration of the difference in sensitivity between the vertical direction and the horizontal direction, and the kernel (second kernel W2) set in consideration of the transferability of a foreign matter during exposure to the specimen image in a combined manner.

In the above description, the first kernel W applied to the specimen image is the kernel set in consideration of the difference in sensitivity between the vertical direction and the horizontal direction, and the second kernel W2 applied to the difference image is the kernel set in consideration with the transferability of a foreign matter during exposure. However, there is no limitation thereto. The second kernel W2 to be applied to the difference image may be the kernel set in consideration of the difference in sensitivity between the vertical direction and the horizontal direction, and the first kernel W to be applied to the specimen image may be the kernel set in consideration with the transferability of a foreign matter during exposure.

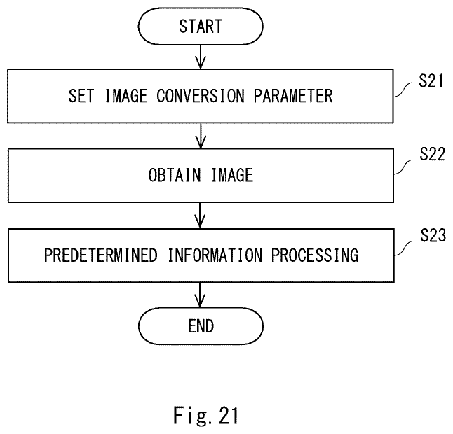

FIG. 21 is a flowchart showing an example image processing method using the image processing device 40 according to the second embodiment. As shown in FIG. 21, the image processing method in the present embodiment includes step S21 of setting the image conversion parameter, step S22 of obtaining an image, and step S23 of performing predetermined information processing. Note that steps S21 and S22 may be performed in reverse order or in parallel.

In step S21, the setting unit 42 sets the image conversion parameter, based on the first sample image area that is the area including the first pattern extending in the first direction on the reference image plane, and the second sample image area that is the area including the second pattern extending in the second direction orthogonal to the first direction on the reference image plane. The image conversion parameter may include a kernel which has a two-dimensional parameter corresponding to the first direction and the second direction and in which the parameter distribution mode is asymmetric between the first direction and the second direction. Note that in step S21, the setting unit 42 may set the image conversion parameter, based on the transferability of a defect on the specimen.

The setting unit 42 may set an image conversion parameter, based on the luminance distribution, along the first direction, of an area of interest in an image based on comparison between a captured image of the target object and a reference image corresponding to the captured image when the relative orientation between the target object and the predetermined image capturing optical system is a predetermined orientation, with the plane of the image based on the comparison being adopted as the reference image plane, and on the luminance distribution, along the second direction, of a rotated area of interest that is an area corresponding to the area of interest in an image based on comparison between a captured image of the target object and a reference image corresponding to the captured image when the relative orientation between the target object and the predetermined image capturing optical system is an orientation different substantially by 90° from the predetermined orientation, with the plane of the image based on the comparison being adopted as the reference image plane.

In step S22, the obtaining unit 41 obtains an image. The obtaining unit 41 obtains a specimen image that is, for example, a captured image of a specimen taken through the predetermined image capturing optical system. The obtaining unit 41 may obtain the captured image of the target object taken through the predetermined image capturing optical system having an NA that differs between the first direction and the second direction orthogonal to the first direction on the reference image plane. The obtaining unit 41 may obtain the captured image of the target object taken through the predetermined image capturing optical system having an imaging magnification that differs between the first direction and the second direction orthogonal to the first direction on the reference image plane.

In step S23, the processing unit 43 performs predetermined information processing of applying the image conversion parameter to the specimen image or an image based on the specimen image. The predetermined information processing may be a process of applying the kernel to the specimen image, or a process of applying the kernel to the difference image. The predetermined information processing may be the aforementioned process using the corrected specimen image and the corrected difference image.

Although the embodiments of the present disclosure are thus described above, the present disclosure encompasses appropriate modifications without impairing the object and advantage. Furthermore, there is no limitation by the embodiments described above. Those with some components in the mentioned embodiments being appropriately omitted or combined are also encompassed by the technical thought of the present disclosure. The following configuration is also encompassed by the technical though of the embodiments.

### (Supplementary Note 1)

An image processing method comprising:
a step of setting a first parameter for a first pattern extending in a first direction on a reference image plane, based on a first sample image area that is an area including the first pattern;
a step of setting a second parameter for a second pattern extending in a second direction orthogonal to the first direction on the reference image plane, based on a second sample image area that is an area including the second pattern;
a step of obtaining a specimen image that is a captured image taken through a predetermined image capturing optical system by capturing an image of a specimen that has a third pattern extending in the first direction in the captured image and a fourth pattern extending in the second direction, with a plane of the captured image being adopted as the reference image plane; and
a step of performing predetermined information processing based on the first parameter and the second parameter, for the specimen image.

### (Supplementary Note 2)

The image processing method according to supplementary note 1, wherein
the step of setting the first parameter sets the first parameter so as to include a threshold used for determination of presence or absence of a defect in the third pattern included in the specimen image,
the step of setting the second parameter sets the second parameter so as to include a threshold used for determination of presence or absence of a defect in the fourth pattern included in the specimen image, and
the step of performing the predetermined information processing performs the predetermined information processing that includes the determination of presence or absence of a defect in the third pattern and the fourth pattern that are included in the specimen image.

### (Supplementary Note 3)

The image processing method according to supplementary note 2, wherein
the specimen image includes both the third pattern and the fourth pattern, and
the step of performing the predetermined information processing performs the predetermined information processing that includes the determination of presence or absence of a defect in the third pattern and the fourth pattern that are included in the specimen image.

### (Supplementary Note 4)

The image processing method according to supplementary note 2, wherein the step of setting the first parameter and the step of setting the second parameter set the threshold for a plurality of types of physical quantities for information about the specimen image.

### (Supplementary Note 5)

The image processing method according to supplementary note 4, wherein
the step of setting the first parameter and the step of setting the second parameter perform setting such that at least an item between the types and number of physical quantities about which the threshold is defined as the first parameter is different from the item of the physical quantities about which the threshold is defined as the second parameter.

### (Supplementary Note 6)

The image processing method according to supplementary note 1, further comprising a step of obtaining the first sample image area and the second sample image area,
wherein in the step of obtaining the first sample image area and the second sample image area, at least any of the first sample image area and the second sample image area is an area included in an image generated based on design data for the specimen or design data for a pattern formed on the specimen.

### (Supplementary Note 7)

The image processing method according to supplementary note 1, wherein the first sample image area is an area included in the captured image of a target object having the first pattern, the captured image having been taken through the predetermined image capturing optical system.

### (Supplementary Note 8)

The image processing method according to supplementary note 7, wherein the first sample image area and the second sample image area are areas included in the captured image of a target object having the first pattern and the second pattern, the captured image having been taken through the predetermined image capturing optical system.

### (Supplementary Note 9)

The image processing method according to supplementary note 7, wherein
the first sample image area and the second sample image area are areas included in the captured image of the target object having the first pattern, the captured image having been taken through the predetermined image capturing optical system, and
an orientation of the target object with respect to the predetermined image capturing optical system during capture of the captured image including the first sample image area, and an orientation of the target object with respect to the predetermined image capturing optical system during capture of the captured image including the second sample image area differ by 90° on a principal plane of the target object.
   (Supplementary Note 10) The image processing method according to supplementary note 7, wherein
the predetermined image capturing optical system captures an image with oblique incidence illumination on the target object, and the first sample image area is included in the captured image when an angle between a direction in which a principal axis of the oblique incidence illumination is projected on an upper surface of the target object, and the first direction is a predetermined angle.

### (Supplementary Note 11)

The image processing method according to supplementary note 9, wherein
the predetermined image capturing optical system captures an image with oblique incidence illumination on the target object, and
the first sample image area and the second sample image area are included in the captured image when an angle between a direction in which a principal axis of the oblique incidence illumination is projected on an upper surface of the target object, and the first direction is a predetermined angle.

### (Supplementary Note 12)

The image processing method according to supplementary note 1, wherein the predetermined image capturing optical system captures an image with oblique incidence illumination on the specimen, and
the specimen image is a captured image taken through the predetermined image capturing optical system when an angle between a direction in which a principal axis of the oblique incidence illumination is projected on an upper surface of the specimen, and the first direction is a predetermined angle.

### (Supplementary Note 13)

In the image processing method according to supplementary note 12, the specimen may include an anamorphic mask.

### (Supplementary Note 14)

The image processing method according to supplementary note 1, wherein the step of obtaining the captured image obtains the specimen image where the number of pixels for binning differs between the first direction and the second direction.

### (Supplementary Note 15)

The image processing method according to supplementary note 1, wherein the step of obtaining the captured image obtains the captured image taken by the image capturing optical system having an NA that differs between the first direction and the second direction.

### (Supplementary Note 16)

The image processing method according to supplementary note 1, wherein
the step of setting the first parameter sets the first parameter so as to include a correction value for luminances of pixels belonging to the third pattern included in the specimen image,
the step of setting the second parameter sets the second parameter so as to include a correction value for luminances of pixels belonging to the fourth pattern included in the specimen image, and
the step of performing the predetermined information processing performs the predetermined information processing that includes image correction for the specimen image.

### (Supplementary Note 17)

A method of using an optical apparatus, the method comprising:
a step of illuminating the specimen;
a step of capturing an image of the illuminated specimen; and
the image processing method according to any one of supplementary notes 1 to 16.

A program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

1. An image processing device comprising:
a setting unit configured to set a first parameter for a first pattern extending in a first direction on a reference image plane, based on a first sample image area that is an area including the first pattern, and
set a second parameter for a second pattern extending in a second direction orthogonal to the first direction on the reference image plane, based on a second sample image area that is an area including the second pattern;
an obtaining unit configured to obtain a specimen image that is a captured image taken through a predetermined image capturing optical system by capturing an image of a specimen that has a third pattern extending in the first direction in the captured image and a fourth pattern extending in the second direction, with a plane of the captured image being adopted as the reference image plane; and
a processing unit configured to perform predetermined information processing based on the first parameter and the second parameter, for the specimen image.

2. The image processing device according to claim 1, wherein
the setting unit sets the first parameter so as to include a threshold used for determination of presence or absence of a defect in the third pattern included in the specimen image, and
sets the second parameter so as to include a threshold used for determination of presence or absence of a defect in the fourth pattern included in the specimen image, and
the processing unit performs the predetermined information processing that includes the determination of presence or absence of a defect in the third pattern and the fourth pattern that are included in the specimen image.

3. The image processing device according to claim 2, wherein
the specimen image includes both the third pattern and the fourth pattern, and
the processing unit performs the predetermined information processing that includes the determination of presence or absence of a defect in the third pattern and the fourth pattern that are included in the specimen image.

4. The image processing device according to claim 2, wherein the setting unit sets the threshold for a plurality of types of physical quantities for information about the specimen image.

5. The image processing device according to claim 4, wherein the setting unit performs setting such that at least an item between the types and number of the physical quantities about which the threshold is defined as the first parameter is different from the item of the physical quantities about which the threshold is defined as the second parameter.

6. The image processing device according to claim 1, wherein at least any of the first sample image area and the second sample image area is an area included in an image generated based on design data for the specimen or design data for the pattern formed on the specimen.

7. The image processing device according to claim 1, wherein the first sample image area is an area included in the captured image of a target object having the first pattern, the captured image having been taken through the predetermined image capturing optical system.

8. The image processing device according to claim 7, wherein the first sample image area and the second sample image area are areas included in the captured image of a target object having the first pattern and the second pattern, the captured image having been taken through the predetermined image capturing optical system.

9. The image processing device according to claim 7, wherein
the first sample image area and the second sample image area are areas included in the captured image of the target object having the first pattern, the captured image having been taken through the predetermined image capturing optical system, and
an orientation of the target object with respect to the predetermined image capturing optical system during capture of the captured image including the first sample image area, and an orientation of the target object with respect to the predetermined image capturing optical system during capture of the captured image including the second sample image area differ by 90° on a principal plane of the target object.

10. The image processing device according to claim 7, wherein
the predetermined image capturing optical system captures an image with oblique incidence illumination on the target object, and
the first sample image area is included in the captured image when an angle between a direction in which a principal axis of the oblique incidence illumination is projected on an upper surface of the target object, and the first direction is a predetermined angle.

11. The image processing device according to claim 8, wherein
the predetermined image capturing optical system captures an image with oblique incidence illumination on the target object, and
the first sample image area and the second sample image area are included in the captured image when an angle between a direction in which a principal axis of the oblique incidence illumination is projected on an upper surface of the target object, and the first direction is a predetermined angle.

12. The image processing device according to claim 1, wherein
the predetermined image capturing optical system captures an image with oblique incidence illumination on the specimen, and
the specimen image is a captured image taken through the predetermined image capturing optical system when an angle between a direction in which a principal axis of the oblique incidence illumination is projected on an upper surface of the specimen, and the first direction is a predetermined angle.

13. The image processing device according to claim 12, wherein the specimen includes an anamorphic mask.

14. The image processing device according to claim 1, wherein the obtaining unit obtains the specimen image where the number of pixels for binning differs between the first direction and the second direction.

15. The image processing device according to claim 1, wherein the predetermined image capturing optical system has an NA that differs between the first direction and the second direction.

16. The image processing device according to claim 1, wherein
the setting unit sets the first parameter so as to include a correction value for luminances of pixels belonging to the third pattern included in the specimen image, and
sets the second parameter so as to include a correction value for luminances of pixels belonging to the fourth pattern included in the specimen image, and
the processing unit performs the predetermined information processing that includes image correction for the specimen image.

17. An image processing device comprising:
a setting unit configured to set an image conversion parameter, based on a first sample image area that is an area including a first pattern extending in a first direction on a reference image plane, and a second sample image area that is an area including a second pattern extending in a second direction orthogonal to the first direction on the reference image plane;
an obtaining unit configured to obtain a specimen image that is a captured image of a specimen taken through a predetermined image capturing optical system; and
a processing unit configured to perform predetermined information processing of applying the image conversion parameter, for the specimen image, or an image based on the specimen image.

18. An image processing device comprising:
an obtaining unit configured to obtain a captured image of a target object taken through a predetermined image capturing optical system having an NA that differs between the first direction and the second direction orthogonal to the first direction on a reference image plane;
a setting unit configured to set an image conversion parameter, based on a luminance distribution, along the first direction, of an area of interest of an image based on comparison between a captured image of the target object and a reference image corresponding to the captured image when a relative orientation between the target object and the predetermined image capturing optical system is a predetermined orientation, with a plane of the image based on the comparison being adopted as the reference image plane, and on a luminance distribution, along the second direction, of a rotated area of interest that is an area corresponding to the area of interest in an image based on comparison between a captured image of the target object and a reference image corresponding to the captured image when a relative orientation between the target object and the predetermined image capturing optical system is an orientation different substantially by 90° from the predetermined orientation, with a plane of the image based on the comparison being adopted as the reference image plane; and
a processing unit configured to perform predetermined information processing of applying the image conversion parameter to a specimen image that is a captured image of a specimen taken through the predetermined image capturing optical system or an image based on the specimen image.

19. The image processing device according to claim 17, wherein the image conversion parameter includes a kernel which has a two-dimensional parameter corresponding to the first direction and the second direction and in which a distribution mode of the parameter is asymmetric between the first direction and the second direction.

20. An optical apparatus comprising:
an illumination optical system configured to illuminate the specimen;
the predetermined image capturing optical system configured to capture an image of the illuminated specimen; and
the image processing device according to claim 1.

21. An image processing method comprising:
a step of setting a first parameter for a first pattern extending in a first direction on a reference image plane, based on a first sample image area that is an area including the first pattern;
a step of setting a second parameter for a second pattern extending in a second direction orthogonal to the first direction on the reference image plane, based on a second sample image area that is an area including the second pattern;
a step of obtaining a specimen image that is a captured image taken through a predetermined image capturing optical system by capturing an image of a specimen that has a third pattern extending in the first direction in the captured image and a fourth pattern extending in the second direction, with a plane of the captured image being adopted as the reference image plane; and
a step of performing predetermined information processing based on the first parameter and the second parameter, for the specimen image.

22. An image processing method comprising:
a step of setting an image conversion parameter, based on a first sample image area that is an area including a first pattern extending in a first direction on a reference image plane, and a second sample image area that is an area including a second pattern extending in a second direction orthogonal to the first direction on the reference image plane;
a step of obtaining a specimen image that is a captured image of a specimen taken through a predetermined image capturing optical system; and
a step of performing predetermined information processing of applying the image conversion parameter, for the specimen image, or an image based on the specimen image.

23. An image processing method comprising:
a step of obtaining a captured image of a target object taken through a predetermined image capturing optical system having an NA that differs between the first direction and the second direction orthogonal to the first direction on a reference image plane;
a step of setting an image conversion parameter, based on a luminance distribution, along the first direction, of an area of interest of an image based on comparison between a captured image of the target object and a reference image corresponding to the captured image when a relative orientation between the target object and the predetermined image capturing optical system is a predetermined orientation, with a plane of the image based on the comparison being adopted as the reference image plane, and on a luminance distribution, along the second direction, of a rotated area of interest that is an area corresponding to the area of interest in an image based on comparison between a captured image of the target object and a reference image corresponding to the captured image when a relative orientation between the target object and the predetermined image capturing optical system is an orientation different substantially by 90° from the predetermined orientation, with a plane of the image based on the comparison being adopted as the reference image plane; and
a step of performing predetermined information processing of applying the image conversion parameter to a specimen image that is a captured image of a specimen taken through the predetermined image capturing optical system or an image based on the specimen image.

24. The image processing method according to claim 22, wherein the image conversion parameter includes a kernel which has a two-dimensional parameter corresponding to the first direction and the second direction and in which a distribution mode of the parameter is asymmetric between the first direction and the second direction.

25. A method of using an optical apparatus, the method comprising:
a step of illuminating the specimen;
a step of capturing an image of the illuminated specimen; and
the image processing method according to claim 21.
